(19) United States
(12) Patent Application Publication
(10) Pub. No.: US 2026/0253308 A1
(43) Pub. Date: Aug. 27, 2026

(54) REDUCED MEMORY SUPER-SAMPLING

(71) Applicant: Meta Platforms Technologies, LLC, Menlo Park, CA (US)

(72) Inventor: Mark Lawrence, Bainbridge Island, WA (US)

(21) Appl. No.: 19/373,458

(22) Filed: Oct. 29, 2025

Related U.S. Application Data
(60) Provisional application No. 63/713,698, filed on Oct. 30, 2024.

(51) Int. Cl. G06T 15/04; G06T 3/4053; G06T 5/73; G06T 15/50

(52) U.S. Cl. CPC G06T 15/04; G06T 3/4053; G06T 5/73; G06T 15/503

(57) ABSTRACT

The disclosed computer-implemented method may include receiving a texture memory that represents a rendering of a display frame and includes a color value for each of a plurality of pixels, and receiving a coverage bitmap that represents a foreground object of the display frame with respect to the plurality of pixels. The method may also include reprojecting the texture memory using the coverage bitmap, and displaying the reprojected texture memory on the display. Various other methods, systems, and computer-readable media are also disclosed.

### CROSS REFERENCE TO RELATED APPLICATION

This application claims the benefit of U.S. Provisional Application No. 63/713,698, filed Oct. 30, 2024, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example rendering pipeline for an artificial reality (AR) system.

FIG. 2 is a flow diagram of an example method for super-sampling for reprojection.

FIGS. 3A-D are diagrams of pixel color values using super-sampled color values.

FIG. 4 is a flow diagram of an example process for super-sampling using a coverage bitmap.

FIG. 5 is an illustration of an example artificial-reality system according to some embodiments of this disclosure.

FIG. 6 is an illustration of an example artificial-reality system with a handheld device according to some embodiments of this disclosure.

FIG. 7A is an illustration of example user interactions within an artificial-reality system according to some embodiments of this disclosure.

FIG. 7B is an illustration of example user interactions within an artificial-reality system according to some embodiments of this disclosure.

FIG. 8A is an illustration of example user interactions within an artificial-reality system according to some embodiments of this disclosure.

FIG. 8B is an illustration of example user interactions within an artificial-reality system according to some embodiments of this disclosure.

FIG. 9 is an illustration of an example wrist-wearable device of an artificial-reality system according to some embodiments of this disclosure.

FIG. 10 is an illustration of an example wearable artificial-reality system according to some embodiments of this disclosure.

FIG. 11 is an illustration of an example augmented-reality system according to some embodiments of this disclosure.

FIG. 12A is an illustration of an example virtual-reality system according to some embodiments of this disclosure.

FIG. 12B is an illustration of another perspective of the virtual-reality systems shown in FIG. 12A.

FIG. 13 is a block diagram showing system components of example artificial-and virtual-reality systems.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

An artificial reality (AR) display such as the display in a mixed reality (MR) system is unlike a traditional monitor. In particular, due to the optics in an MR display, the color channels are often separated spatially between Red/Green and Blue and are also distorted into a barrel shape. In an MR system, the displays may also be driven indirectly by a wave-guide, such that individual pixels from the red/green and blue channels are also rotated relative to each other, for example, if different projectors are used for each color channel to conserve power. A reprojection compositor ensures that individual pixels in texture memory are written to the display in such a way that they visually appear to the wearer in the same place.

As a consequence, unlike traditional displays, MR displays often do not have a predictable way for applications to render individual display pixels. This precludes many mechanisms used to improve text rendering quality such as hinting (e.g., positioning glyphs vertically so that horizontal lines are aligned on pixels) and clear type rendering (e.g., increasing effective horizontal resolution by individually illuminating RGB or BGR display pixels). Furthermore, bilinear sampling from the textures rendered by applications to offscreen textures may further reduce the sharpness of text rendered to the display inside the reprojection pipeline.

In some examples, “super-sampling,” may refer to increasing a number of pixels in texture memory (e.g., a buffer or data including color values for each pixel). If the renderer renders more than one color sample per display pixel to texture memory, then the reprojection compositor may more accurately illuminate the final display pixels especially around the edges of shapes that define text. This results in increased memory consumption and increased memory-bus bandwidth for both the application and the reprojection pipeline. Each full color pixel value produced doubles the memory utilization in texture memory. In addition the application must often be aware of the fact that it needs to produce super-sampled output.

Although moving the renderer into the Reprojection Compositor (e.g., Render to Display) may be possible, rendering directly to the display is computationally expensive and runs the risk of creating scenes that cannot be rendered by a ray-tracer, resulting in increased latency in relation to head movement (increasing the risk of nausea) or resulting in increased power consumption (to accommodate the increased computation) or result in tearing or visual artifacts if the ray tracer cannot keep up. Alternatively moving the renderer into the Reprojection Compositor but limiting complexity by using Signed Distance Fields (SDFs), may address some of the aforementioned issues. However, a disadvantage of this is that SDF's may work well for magnification and may work less well for minification, and are also expensive to produce. For certain rendering issues, such as rendering small text, the advantages of SDF's are limited.

As such, there is a need for new approaches to improve sharpness of text in MR displays.

The present disclosure is generally directed to reprojection using super-sampling. As will be explained in greater detail below, embodiments of the present disclosure may receive a texture memory for a display frame and a corresponding coverage bitmap that represents a foreground object of the display frame, reprojection the texture memory using the coverage bitmap (e.g., performing super-sampling and then reprojection), and displaying the reprojections texture memory on a display. The systems and methods described herein may advantageously improve display technology, particularly reprojection for AR displays, by improving color value calculations that may better preserve original frame fidelity. The systems and methods described herein may further improve the functioning of a computing device itself by providing a memory efficient super-sampling that may be used in a rendering pipeline that includes reprojection.

Features from any of the embodiments described herein may be used in combination with one another in accordance with the general principles described herein. These and other embodiments, features, and advantages will be more fully understood upon reading the following detailed description in conjunction with the accompanying drawings and claims.

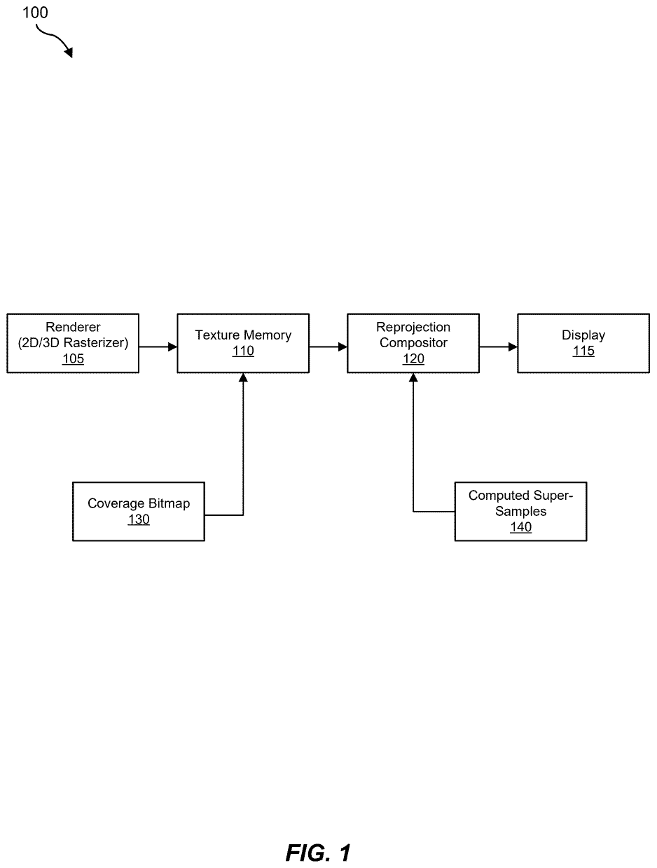

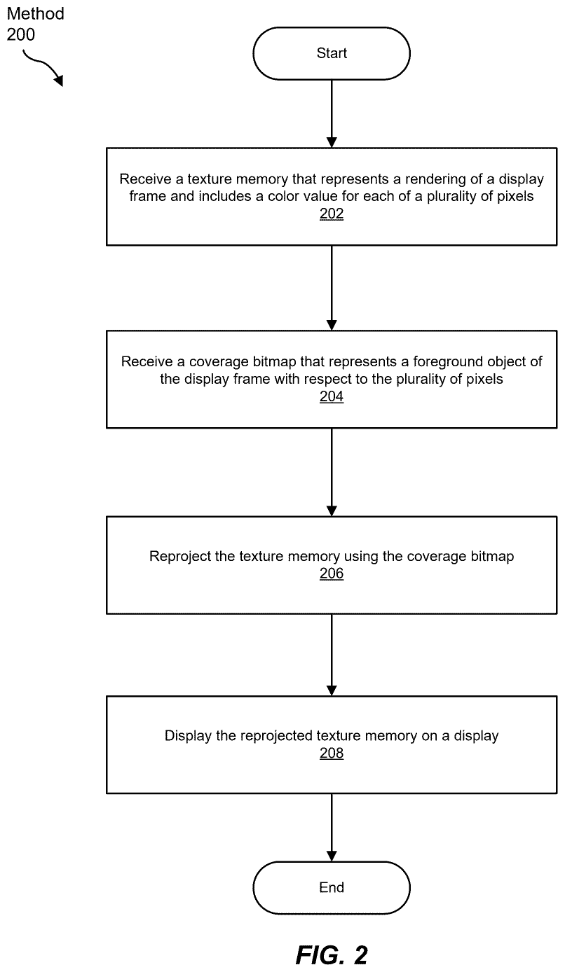

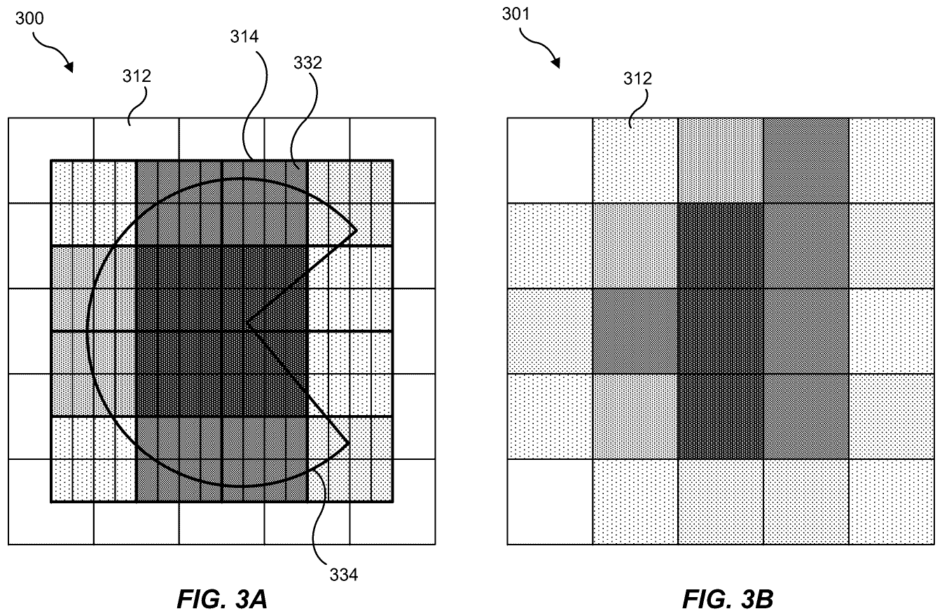

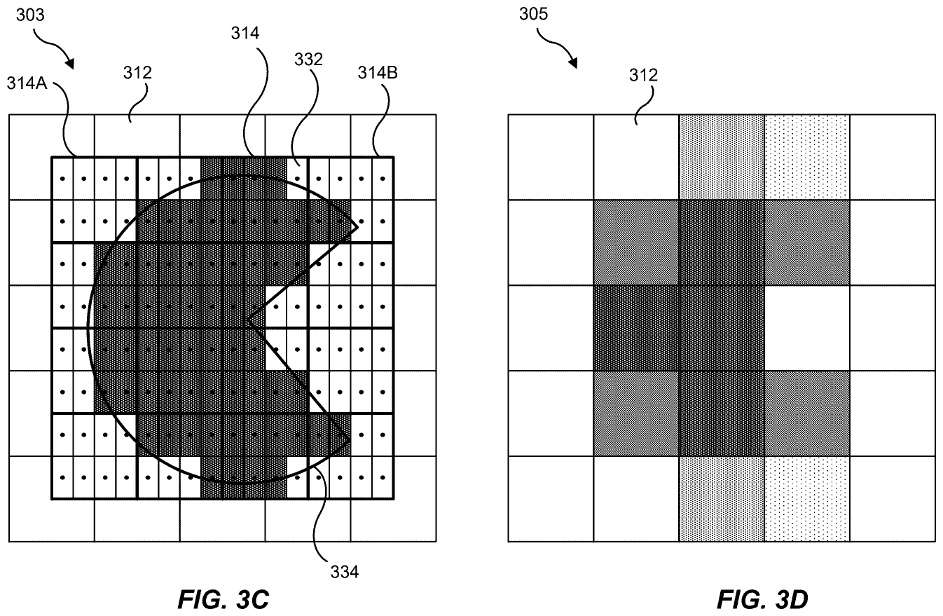

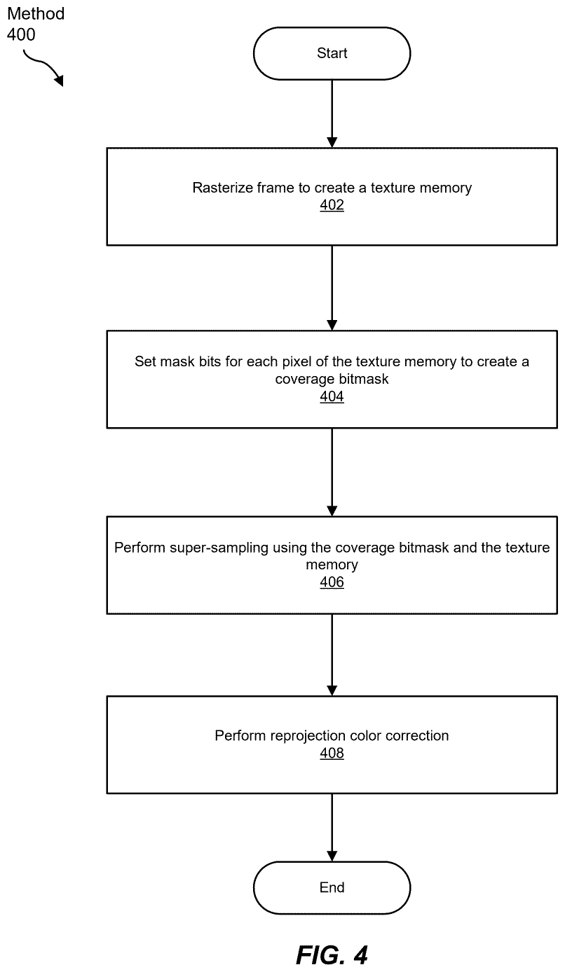

The following will provide, with reference to FIGS. 1-4, detailed descriptions of super-sampling for reprojection. Detailed descriptions of a rendering pipeline will be provided in connection with FIG. 1. Detailed descriptions of methods of super-sampling will be provided in connection with FIGS. 2 and 4. In addition, detailed descriptions of super-sampling with a coverage bitmap will be provided in connection with FIGS. 3A-3D.

FIG. 1 illustrates an artificial reality (AR) rendering pipeline 100, according to some implementations. In some examples, pipeline 100 may be implemented by any computing device and/or display, including AR system 1100, VR system 1200, etc. (described further below). Pipeline 100 includes a renderer 105 (e.g., a 2D and/or 3D rasterizer), which may be implemented in software, or alternatively in silicon on a chip, for converting display data (e.g., data relating to objects, textures, surfaces, colors, etc. for a given frame of an AR application to be displayed) into image data. Renderer 105 renders a scene (e.g., a particular frame of display data from the application) to a texture memory 110 (e.g., a data object representing color values for each pixel of the frame). Texture memory 110 may sampled from and rendered to a display 115 (e.g., an AR display device, examples of which are described further below) and reprojected, as the head moves, by a reprojection compositor 120, which may be implemented in software, or alternatively in silicon on a chip, for reprojection (e.g., a computer graphics technique for reducing perceived latency in display framerate by taking one or more previously rendered frames and using motion information from the user's headset to reproject the previously rendered frames and predict a newly rendered frame). Display 115 may have various forms of reduced fidelity.

FIG. 1 further illustrates that the textures stored in texture memory 110 (e.g., one or more rendered frame) may be augmented with a coverage bitmap 130 (also referred to equivalently herein as a coverage bitmask) that indicates which sub-pixels of the original shape were covered by the geometry which rendered the 2D scene, as will be described further below. Where text is rendered with high quality, it may be to a texture with a consistent background color. The text may be rendered as shapes in a 2D renderer using curves that are defined with sub-pixel precision. For example, the text (or other desired object) may be rendered with a foreground color over the background with a background color.

In some examples, renderer 105 may be configured to produce coverage bitmap 130 as well as the normal anti-aliased texture color (and optionally, alpha) values. Each bit in coverage bitmap 130 (e.g., a bitmask) may represent a pixel that was covered by a color (e.g., foreground color) that is not the background color of the texture to which the text is rendered. This bitmask is cleared to all 0's when the texture is first filled with the background color (representing no foreground color covering the background color) and then accumulates all of the sub-pixels that have been covered by shapes when the scene was rendered by the 2D IP, ignoring the color that was written to the pixel.

As will be described further below, reprojection compositor 120 and/or another processor of display 115 may use texture memory 110 and coverage bitmap 130 to generate computed super-samples 140 (e.g., super-sampled data of the original rendered frame that may relate sub-pixels to foreground/background color values). This augmented super-sampled texture (e.g., computed super-samples 140) may then be consumed by reprojection compositor 120 to correctly illuminate the destination pixels resulting in sharper text, as will be described further below.

Turning to FIG. 2, FIG. 2 is a flow diagram of an example computer-implemented method 200 for super-sampling for reprojection. The steps shown in FIG. 2 may be performed by any suitable computer-executable code and/or computing system, including the system(s) illustrated in FIGS. 1 and 5-13. In one example, each of the steps shown in FIG. 2 may represent an algorithm whose structure includes and/or is represented by multiple sub-steps, examples of which will be provided in greater detail below.

As illustrated in FIG. 2 at step 202 one or more of the systems described herein may receive a texture memory that represents a rendering of a display frame and includes a color value for each of a plurality of pixels. For example, renderer 105 may generate texture memory 110 that is received by reprojection compositor 120.

The systems described herein may perform step 202 in a variety of ways. In one example, the color value for each of the plurality of pixels (e.g., pixels of texture memory 110, which may correspond to pixels of a frame and/or display) may correspond to multiple color channels, such as R, G, B. In some examples, one of the multiple color channels may correspond to an alpha channel.

At step 204 one or more of the systems described herein may receive a coverage bitmap that represents a foreground object of the display frame with respect to the plurality of pixels. For example, reprojection compositor 120 may receive coverage bitmap 130.

The coverage bitmap/bitmask will be described further in connection with FIGS. 3A-3D. FIG. 3A illustrates a reprojection 300. FIG. 3A includes display pixels 312 (e.g., illustrated as boxes in a 5×5 arrangement, and corresponding to pixels of a display device such as display 115), texture pixels 314 (e.g., illustrated as boxes with similar areas as but thicker borders than display pixels 312 and in a 4×4 texture arrangement, and corresponding to pixels of a texture memory such as texture memory 110), and sub-pixels 332 (e.g., illustrated as rectangles smaller than display pixels 312 and texture pixels 314 and more particularly ⅛ the size). Sub-pixels 332 may further represent a bitmask/bitmap in a 2×4 mask (e.g., 2×4 arrangement per texture pixel 314), although in other examples, other arrangements may be used. In addition, FIG. 3A illustrates a simplified pixel arrangement for explanatory reasons. In other examples, other pixel arrangements may be used.

FIG. 3A illustrates a single color channel (e.g., monochrome, in which a “1” value for a pixel may represent a highest intensity and a “0” value represents a lowest intensity, although other scales/values may be used). For simplified explanation and illustration, FIG. 3A represents value 1 with a dark gray, which further represents the object color or foreground color, and 0 with white, which represents the background color, with the various shades of gray (e.g., density of dotted pattern) representing values between 1 and 0. In addition, other aspects, such as barrel distortion or other color channel separation, are not modeled for simplicity.

FIG. 3A further illustrates an object outline 334 (e.g., a pie shape) representing an object (e.g., of a foreground color) to be overlayed onto a background for rendering a frame. The object represented by object outline 334 may be solidly filled with the foreground color. Due to object outline 334 not adhering to the pixels (e.g., partially covering pixels, particularly around outer edges of the object, rather than conforming to pixel shapes), the rendered color may be blended between the foreground color and the background color via approximation. Although any appropriate interpolation between foreground color and background color may be used, generally a higher number of sub-pixels 332 covered by the object (e.g., partially/completely within object outline 334) may correspond to a higher intensity of the foreground color (e.g., lower intensity of the background color). Similarly, a lower number of sub-pixels 332 not covered by the object (e.g., partially/completely outside of object outline 334) may correspond to a lower intensity of the foreground color (e.g., higher intensity of the background color). In addition, any appropriate metric for determining whether a given sub-pixel 332 is within object outline 334 may be used (e.g., threshold percent of area being within object outline 334, midpoint of sub-pixel 332 being within object outline 334, etc.). FIG. 3A therefore illustrates how the object may be rendered (e.g., for texture memory 110), with the 4×4 grid of texture pixels 314.

During reprojection, the original pixels of the texture memory may not align with the display pixels (e.g., if interpolating headset motion to keep a displayed object in a same location relative to a user's perspective) such that a prediction (e.g., interpolation) may be used to estimate color values for the display pixels. FIG. 3A illustrates a simplified example in which the offset (representing the motion or other reprojection) aligns with sub-pixels 332 (e.g., a shift of two sub-pixels vertically and two sub-pixels horizontally) for explanatory reasons. In this simplified example, the color value for each display pixel 312 may conceptually be calculated by interpolating between the background color and the foreground colors of corresponding sub-pixels 332 (e.g., bilinearly sampled). The result of this reprojection is illustrated in FIG. 3B.

FIG. 3B illustrates a display frame 301 (corresponding to a reprojection of texture memory 110 as may be displayed on display 115). FIG. 3B illustrates, for example, the shape rendered to texture and then bilinearly sampled to a display. As compared to FIG. 3A, the reprojection may have further “diluted” the colors around the edges of the object or bled out colors into the surrounding pixels.

FIG. 3C illustrates a coverage bitmap 303 (corresponding to coverage bitmap 130). In the example of FIG. 3C, a centroid sampling strategy is used, by determining whether the centroid of each sub-pixel 332 (depicted by a dot within each sub-pixel) is inside the shape (e.g., object outline 334). If the centroid of the pixel is inside the shape, the corresponding sub-pixel 332 may be marked/set in the coverage bitmap. For example, a texture pixel 314A may have 0 covered sub-pixels 332, and a texture pixel 314B may have 2 covered sub-pixels 332. Although FIG. 3C represents a centroid sampling strategy, in other examples, other sampling strategies may be used, such as using coverage and marking the sub-pixel if more than a threshold area (e.g., half) is covered, etc.

To determine an appropriate foreground color, the extent to which the coverage mask over or underestimated the actual coverage of the pixel may be determined and then the colors separated. The final pixel values may then be chosen based on the average color coverage value of the resulting bitmap (e.g., a form of linear interpolation which in some examples may relate to a number of marked sub-pixels for each display pixel). For instance, a higher number of marked sub-pixels may correspond to a higher intensity of foreground color (and lower intensity of background color), and a lower number of marked sub-pixels may correspond to a lower intensity of foreground color (and higher intensity of background color). In some examples, the super-sampled color bitmap may not be stored. For example, the bitmap may be computed on the fly by reprojection compositor 120 using the source data (e.g., texture memory 110 and coverage bitmap 130, producing computed super-samples 140).

FIG. 3D illustrates a display frame 305 (corresponding to a reprojection of texture memory 110 incorporating computed super-samples 140 and as may be displayed on display 115). FIG. 3D visualizes how super-sampled color values can be reconstructed, and the effect of re-separating color values and reassigning to a coverage mask, and then using coverage to render the display. As can be seen by comparing FIG. 3B and FIG. 3D, the resulting color values are “sharper” in the super-sampled approach, with less dilution/bleed out at the surrounding pixels. In FIG. 3B, much of the original shape has been averaged across the pixels such that the original shape may be difficult to discern. Although the example object may represent only a portion of a glyph in practice, the example demonstrates that the super-sampled approach may provide sharper results by coloring the final display pixels more accurately, with respect to the reprojection pipeline.

Super-sampling using coverage bitmaps/bitmasks will now be described in connection with a method 400 in FIG. 4. At 402, a renderer (e.g., renderer 105) may rasterize a frame to create a texture memory (e.g., texture memory 110). The rasterizing may include overlaying an object (e.g., text as represented by one or more glyphs) onto a background and determining appropriate color values (e.g., for one or more color channels) for each pixel of the texture memory.

At 404, the renderer may set mask bits for each pixel of the texture memory. At the end of rasterizing the scene (e.g., for the frame) the pixels (of the texture memory) may be rendered (e.g., if part of a foreground object/shape such as a glyph) or not rendered (e.g., not in the shape). Pixels not rendered at all may have the original fill color and a zero filled mask (e.g., the mask bits of the corresponding sub-pixels set to 0). Pixels that were entirely interior to a shape may have the original shape color and all mask bits set (e.g., the mask bits of the corresponding sub-pixels set to 1). Pixels that are on the edge of shapes may have a color that has been computed using what portion of the pixels were covered AND a partially set mask. These pixels may define the edges of the glyphs in the text being rendered. Accordingly, a coverage bitmask (e.g., coverage bitmap 130) may include a bitmask for each pixel of the texture memory, that indicates a number of sub-pixels of the pixel that covered (e.g., in the shape). This bitmask may be a series of bit values (e.g., 8 bits corresponding to 8 sub-pixels, each set bit indicating a covered sub-pixel), although in other examples, the coverage may be encoded in other ways (e.g., as a binary number value).

In some examples, the entire texture may be opaque. In this case, the alpha channel from the originally rendered image may be discarded and replaced with this coverage bitmask. This representation may use no more memory than the original image since pixels may be packed to 32 bit boundaries anyway (e.g., 8 bits per channel, including R, G, B, and alpha).

With no compression, an 8 bit mask may approximate an 8× super-sampled texture but using only 25% more memory. Similarly, a 16 bit mask may approximate a 16× super-sampled texture but using 50% more memory.

In some implementations, additional memory savings can be obtained by observing that most pixels will either be filled (all zeroes or other appropriate boundary value), or not filled (all ones or other appropriate complementary boundary value) and that since most pixels represent the interior of filled curves, some bitmasks patterns are extremely unlikely. This may be encoded using the leading 2 bits of each pixel, in one example. “00” may indicate that the pixel is not filled. “01” may indicate that the pixel is filled. “10” followed by a bit string (IIIIII) may indicate that the pixel is filled with a value to be retrieved from a compression table. “11” for a bit string “XXXXXXXX” may indicate a pixel mask of X.

At step 406, a reprojection compositor (e.g., reprojection compositor 120) may perform super-sampling using the coverage bitmask and the texture memory, to produce super-samples for display (e.g., computed super-samples 140 for display on display 115).

As the covered pixels and not covered pixels may retain their color values (e.g., from the texture memory), the discussion will focus on partially covered pixels (for the reprojection, with respect to display pixels). In some implementations, the partially covered pixels may be rendered with the following “coverage equation”:

$${C}_{r} = ( 1 - A ) {C}_{d} + A {C}_{s} \qquad Equation 1$$

Where A is the coverage value (e.g., the proportion of the pixel covered), C_{d} is the destination color (which may be known, for instance from the texture memory), and Cₛ is the source color of the pixel (e.g., original foreground color). The reprojection compositor may consume the original texture memory, the rendered bitmask, and the original fill color of the texture (e.g., foreground color). The reprojection compositor may use the following process to re-compute the color values it will need for super-sampling.

The bitmask for a given pixel may be used to provide an approximation for the original coverage value that was used for rasterizing the curve (Aₐ). In the 2×4 sub-pixel arrangement described herein, each pixel may be associated with up to 8 bits. For example if 1 bit is sent then Aₐ is ⅛ or 12.5%. Using the original coverage blend equation, Cᵣ may be known (the color value in the texture for a given pixel). The original C_{d} is also known (the clear color of the target, e.g., background color) and there is an approximation of A (Aₐ, from the coverage bitmask). These can be used to re-derive Cₛ from Equation 1.

$${C}_{s} = ( {C}_{r} + ( {A}_{a} - 1 ) {C}_{d} ) / {A}_{a} \qquad Equation 2$$

As an example (simplifying to a monochrome bitmap), if the original target was white (1), and a 25% color was blending in with 25% coverage, then the final color value will be (using equation 1) Cᵣ=0.75(1)+(0.25)0.25=81.25%. Then to recover the source, given it is known that the target was first cleared to 1, Cₛ can be determined as follows (using equation 2): Cₛ=(0.8125+(0.25−1)1)/0.25=0.25.

Even if A is an approximation of the original coverage, the equation may produce a partial separation of the original color values. In another example, if the original coverage is approximated as 30% and Cₛ would be: Cₛ=(0.8125+(0.30−1)1)/0.30=0.375.

At 408, the reprojection compositor may optionally perform reprojection color correction. In some examples, it is possible to get a sub-luminous and/or super-luminous value from this calculation (e.g., values lower than or greater than boundary color values). Consider the case of a white (1) target rendered at 30% coverage with a black (0) value. This would resulted in the following value (using equation 1) being written into the pixel: Cᵣ=(1−0.30)1+0.30(0)=0.70. If the coverage value (Aₐ) is estimated as 0.25 the original source value would be computed as (using equation 2): Cₛ=(0.70+(0.25−1)1)/0.25=−0.25, a sub-luminous value (e.g., less than 0).

In some examples, it is possible to have super-luminous colors. Consider the same case, but with a black (0) target rendered at 30% coverage with a white (1) value. This would have the following result: Cᵣ=(1−0.30)0+0.30(1)=0.30. If Aₐ is estimated to be 0.25: Cₛ=(0.30+(0.25−1)0)/0.25=1.25, resulting in the following super-luminous value (e.g., greater than 1).

However, render targets may not store negative color values, and even if it could be stored in the render target, most displays may not render the color. Accordingly, the approximation for A (Aₐ) may be too far off from the actual value of A.

In some examples, there may be negative color values in the scRGB color space which correspond to human visible colors in the color gamut. However, even in this case sufficiently negative values may not be visible. These negative values may therefore be clamped to a finite negative value rather than 0, in a color correction operation.

Further, some implementations may take into account that instead of dealing with gray-scale values, there are separate color channels. If any of them were to be clamped any more than the others, the computed final color value for the pixel may effectively be changed. When this is rendered later there may be color shifting because the per-color channel values would be unbalanced relative to each other.

In order address some of the issues described above, it is desirable to find a single value for Aₐ that causes none of the color values to become super-or sub-luminous. This value is known to exist because the original color channels were created with the original blend equation with a single coverage value (A reapproximated coverage value Aₐ₂) may be found as follows, derived from equation 1:

$${A}_{a 2} = ( {C}_{r} - {C}_{d} ) / ( {C}_{s} - {C}_{d} ) \qquad Equation 3$$

For each color channel, C_{d} is known (e.g., the clear color) and Cᵣ is known, and Cₛ cannot be less than 0 or greater than 1 (or otherwise be bounded between boundary values). The color correction may accordingly include: 1) Calculating the color values per channel (as described above). If none of them are outside of 0-1 bounds (or other appropriate boundary values), the color correction ends. 2) Finding the color channel value that is most out of bounds (e.g., for each of the color channels and for each pixel, finding a maximum delta value between the super-sampled color and the nearest boundary value). 3) If the most out of bound value is less than 0 (e.g., less than the lower boundary value), then calculate A using Cₛ=0 (e.g., set Cₛ to the lower boundary value). 4) If the most out of bound value is larger than 1 (e.g., is greater than the upper boundary value) then calculate A using Cₛ=1 (e.g., set Cₛ to the upper boundary value). This recalculated A can then be used to calculate the color channels again.

An example super-sampling is provided, according to some embodiments. Assume that the following color vector was used: [0.05, 0, 0.9] with a coverage value of 0.3. And that the original background color was [0, 1, 0.95]. This will result in a color of: [0.015, 0.7, 0.935].

A may then be approximated with Aₐ with 0.25 (e.g., if using 8 bits as described herein, setting 2 of 8 bits). This results in the following color estimated source color value: [0.06, −0.2, 0.89]. The largest color value discrepancy is −0.2. So, Aₐ may be recalculated as follows (using equation 3). Aₐ=(0.7−1)/(0−1)=0.3. In this example, the original A is calculated. This value may then be used to calculate the original Source color as follows: [0.05, 0, 0.9], which is also the original source value in this example.

In some examples, either the background color or the foreground color can have an alpha channel value. It can be treated just like any other color channel using the mathematics described herein and a final transparency calculated.

Some implementations may utilize transparency directly for coverage. This approach has a number of advantages. For example, the texture can still be used naively to sample color values without the bitmask. If the texture is opaque, the alpha channel can be discarded and instead the bitmask be inserted into the alpha channel, resulting in no additional memory being used.

In some examples, there may be an intrinsic limitation to the accuracy of the estimated coverage alpha value. As an example, given 8 sample points, there is a 12.5% maximum error in the estimate and an average error of 6.25%. An alternative approach of some embodiments may reduce the error estimation to 1/256 (0.4%) but may require more effort to sample from. In this approach, rather than clearing the texture to the background color, it is cleared to transparent, in other words it is cleared entirely to having 0 in the alpha channel. All of the shapes may be rendered using pre-multiplied alpha, so each color channel ends up with the alpha component in it. (RA, BA, GA, A). If it is assumed that the alpha channel was entirely contributed by shaped coverage, then the original fill color must have been: (RA/A, BA/A, GA/A). This color channel may be referred to as Cₛ.

As in preceding examples, an approximated coverage value Aₐ may be derived from the proportion of the pixel covered by the bitmap. In order to prevent the average sample value from the texture from being different from the one computed using ideal coverage value the foreground color should be computed from the original blend equation, the known background color and the approximated coverage value and use this value:

$${C}_{s 2} = ( A / {A}_{a} ) {C}_{s} \qquad Equation 4$$

Similarly, the background color can be re-computed from the blend equation:

$${C}_{d 2} = ( 1 - A / {A}_{a} ) {C}_{d} \qquad Equation 5$$

In some examples, it may be necessary to guard against super-luminous colors, by clamping Cₛ and recomputing A/Aₐ since the source color is known to high accuracy.

Some implementations may provide a straight alpha variant. Straight alpha may refer to the original fill color being the color in the target. However, the rest of the computations as described herein are the same.

In some examples, the source colors may have transparency. This case can be detected by comparing Aₐ with A. If the difference is larger than 1/ (Samples in Bitmap), then the original source color must have contained transparency. In this case, the original approximation and color separation system described above can be used. For example, consider the simplifying case of Aₐ=1 but the alpha channel being 0.5. The pixel may be considered half transparent, which does imply that there will be cases of content being rendered opaque if it is within the quantization limit of Aₐ (e.g., 12.5% for an 8 bit bitmap) using this approach.

Although the examples discussed assume that the entire texture has a single background color, in some implementations, the system may allow different areas of a texture to have different default background colors. This may be described as a set of rectangles with distinct fill colors. Bordering regions that may not be rectangular may then be represented as a completely filled pixel with Aₐ=1.

In some examples, many of the porter duff blend modes may also be represented as bitwise operations alongside the normal color channel mappings. For example: Src Over Dest or Dest Over Src may be a bitwise OR. Src Atop Dest may be bitwise AND. For other blend modes, the normal blend equations may be used and the approximation bitmap set to all 1's. This may turn off any sharpness improvements for that pixel but will still render correctly. This allows for complex composition of documents such as regularly found in a web browser to be supported by rendering each “layer” to a render target augmented with a coverage mask.

In yet other examples, the background may not be the clear color. In this case another color must have been written over the fill color so the bitmask will be all filled. Because only Cₛ is known, the rendered output may be the same as obtained by 2D rasterization.

In some implementations, more than one color value may be written to a single pixel. As an illustrative example, most of the pixel may be written to be “black” but a small blue sub-pixel is written to the top-right corner of the sample. This may add a small amount of blue to the target pixel. This may slightly color ALL of the sub-pixels when the original image is reconstructed. Fortunately, human vision is extremely color insensitive. This property may be exploited in video encoding by separating luminance and color values (for example, in the 32 bit YUYV format) by encoding the same color in blocks of 2 or 4 pixels while varying only the luminance values in the individual pixels. Although this may be uncommon in text rendering (since it requires two different colored glyphs to be within one pixel of each other), the result may likely be an improvement compared to the originally rasterized output.

Returning to FIG. 2, the systems described herein may perform step 204 in a variety of ways. In one example, the coverage bitmap may indicate a number of subpixels, for each of the plurality of pixels of the texture memory, included in the foreground object. In some examples, the coverage bitmap may be encoded as a bitmask pattern, as described above. For instance, the bitmask pattern may include using one or more leading bits as a header and remaining bits as a value from a compression table. In yet other examples, the coverage bitmap may be encoded in the alpha channel, as described herein.

In the examples described herein, a 2×4 8-bit super-sampling mask is used. However, in other examples, other size masks may be used. In addition, the super-sampling mask may vary, including using different masks for different color channels as needed.

At step 206 one or more of the systems described herein may reproject the texture memory using the coverage bitmap. For example, reprojection compositor 120 may use coverage bitmap 130 to determine computed super-samples 140 based on texture memory 110, and use computed super-samples 140 for reprojecting texture memory 110 to a reprojected texture memory.

The systems described herein may perform step 206 in a variety of ways. In one example, reprojecting the texture memory using the coverage bitmap may include determining an original background color with respect to the display frame and determining an original foreground color of the display frame that corresponds to the foreground object. Reprojection compositor 120 may use the original background color and the original foreground color to calculate color values for the reprojected texture memory (e.g., further using computed super-samples 140). The original foreground color may correspond to a plurality of background colors (e.g., the background having more than one color) such that the display frame may be divided into subframes based on grouping common background colors (e.g., having a coverage bitmap for pixels sharing same and/or similar color within a similarity threshold and/or having the foreground color and/or background color embedded in the coverage bitmap).

In some examples, reprojection compositor 120 may detect an out-of-bound value for at least one of the color channels for the plurality of pixels of the reprojected texture memory and perform a reprojection color correction (e.g., correcting for super-and/or sub-luminance as described herein). Performing the reprojection color correction may include identifying a color channel of the multiple color channels having a largest out-of-bound value, adjusting the largest out-of-bound value to a nearest boundary value for a foreground color of the foreground object, and recalculating the reprojected texture memory using the adjusted foreground color.

At step 208 one or more of the systems described herein may display the reprojected texture memory on a display. For example, display 115 may display the reprojected texture memory.

As detailed above, AR and VR displays have color separation and distortion characteristics that may result in blurry text. Common solutions include rendering directly to the display (which may create performance bottlenecks) or to super-sample the output of the rasterizer. The present disclosure provides an efficient way to produce super sampled output at only, for example, a 25-50% memory penalty but achieving, for example, a 8-16× resolution improvement.

Augmenting a 2D rasterizer to output a bitmask as well as the normal rendered output may produce a 8× or 16× super-sampled format. Analytical coverage calculations are inverted, as described herein, to the recompute an 8× or 16× color super-sample in the reprojection pipeline.

### EXAMPLE EMBODIMENTS

Example 1. A computer-implemented method comprising: receiving a texture memory that represents a rendering of a display frame and includes a color value for each of a plurality of pixels; receiving a coverage bitmap that represents a foreground object of the display frame with respect to the plurality of pixels; reprojecting the texture memory using the coverage bitmap; and displaying the reprojected texture memory on a display.

Example 2. The computer-implemented method of Example 1, wherein reprojecting the texture memory using the coverage bitmap further comprises: determining an original background color with respect to the display frame; determining an original foreground color of the display frame that corresponds to the foreground object; and using the original background color and the original foreground color to calculate color values for the reprojected texture memory.

Example 3. The computer-implemented method of Example 2, wherein the original foreground color corresponds to a plurality of background colors, wherein the display frame is divided into subframes based on grouping common background colors.

Example 4. The computer-implemented method of Example 1, 2, or 3, wherein the coverage bitmap indicates a number of subpixels, for each of the plurality of pixels of the texture memory, included in the foreground object.

Example 5. The computer-implemented method of any of Examples 1-4, wherein the coverage bitmap is encoded as a bitmask pattern.

Example 6. The computer-implemented method of Example 5, wherein the bitmask pattern includes using one or more leading bits as a header and remaining bits as a value from a compression table.

Example 7. The computer-implemented method of any of Examples 1-6, wherein the color value for each of the plurality of pixels corresponds to multiple color channels.

Example 8. The computer-implemented method of Example 7, further comprising: detecting an out-of-bound value for at least one of the color channels for the plurality of pixels of the reprojected texture memory; and performing a reprojection color correction.

Example 9. The computer-implemented method of Example 8, wherein performing the reprojection color correction includes: identifying a color channel of the multiple color channels having a largest out-of-bound value; adjusting the largest out-of-bound value to a nearest boundary value for a foreground color of the foreground object; and recalculating the reprojected texture memory using the adjusted foreground color.

Example 10. The computer-implemented method of Example 8 or 9, wherein one of the multiple color channels corresponds to an alpha channel.

Example 11. The computer-implemented method of Example 10, wherein the coverage bitmap is encoded in the alpha channel.

Example 12. A system comprising: a display; at least one physical processor; physical memory comprising computer-executable instructions that, when executed by the physical processor, cause the physical processor to: receive a texture memory that represents a rendering of a display frame and includes a color value for each of a plurality of pixels; receive a coverage bitmap that represents a foreground object of the display frame with respect to the plurality of pixels; reproject the texture memory using the coverage bitmap; and display the reprojected texture memory on the display.

Example 13. The system of Example 12, wherein instructions for reprojecting the texture memory using the coverage bitmap comprises instructions for: determining an original background color with respect to the display frame; determining an original foreground color of the display frame that corresponds to the foreground object; and using the original background color and the original foreground color to calculate color values for the reprojected texture memory.

Example 14. The system of Example 13, wherein the original foreground color corresponds to a plurality of background colors, wherein the display frame is divided into subframes based on grouping common background colors.

Example 15. The system of any of Examples 12-14, wherein: the coverage bitmap is encoded as a bitmask pattern that indicates a number of subpixels, for each of the plurality of pixels of the texture memory, included in the foreground object; and the bitmask pattern includes using one or more leading bits as a header and remaining bits as a value from a compression table.

Example 16. The system of any of Examples 12-15, wherein: the color value for each of the plurality of pixels corresponds to multiple color channels; and the instructions further include instructions for: detecting an out-of-bound value for at least one of the color channels for the plurality of pixels of the reprojected texture memory; and performing a reprojection color correction.

Example 17. The system of Example 16, wherein the instructions for performing the reprojection color correction includes instructions for: identifying a color channel of the multiple color channels having a largest out-of-bound value; adjusting the largest out-of-bound value to a nearest boundary value for a foreground color of the foreground object; and recalculating the reprojected texture memory using the adjusted foreground color.

Example 18. The system of Example 17, wherein one of the multiple color channels corresponds to an alpha channel.

Example 19. The system of Example 17 or 18, wherein the coverage bitmap is encoded in the alpha channel.

Example 20. A non-transitory computer-readable medium comprising one or more computer-executable instructions that, when executed by at least one processor of a computing device, cause the computing device to: receive a texture memory that represents a rendering of a display frame and includes a color value for each of a plurality of pixels; receive a coverage bitmap that represents a foreground object of the display frame with respect to the plurality of pixels; reproject the texture memory using the coverage bitmap; and display the reprojected texture memory on a display.

Clause 1. A method for rendering text, comprising: receiving a shape for rendering on a display; rendering the shape to a texture comprising a plurality of pixels, each pixel having a source value; subdividing the texture into a plurality of subpixels; using a sampling strategy, determining that a first portion of the plurality of subpixels are associated with the shape; using the sampling strategy, determining that a second portion of the plurality of subpixels are not associated with the shape; generating a bitmask by assigning a true value to the first portion and assigning a false value to the second portion; for each pixel in the plurality of pixels, assigning a value to the pixel based on the bitmask and a plurality of subpixels associated with the pixel; and rendering the shape based on assigned values to the plurality of pixels.

Clause 2. A non-transitory computer-readable medium storing a program for rendering text, which when executed by a computer, configures the computer to perform the method of clause 1.

Clause 3. A system for rendering text, comprising: a processor; and a non-transitory computer readable medium storing a set of instructions, which when executed by the processor, configure the system to perform the method of clause 1.

Embodiments of the present disclosure (e.g., portions of pipeline 100 including renderer 105, reprojection compositor 120, and/or display 115) may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed-or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

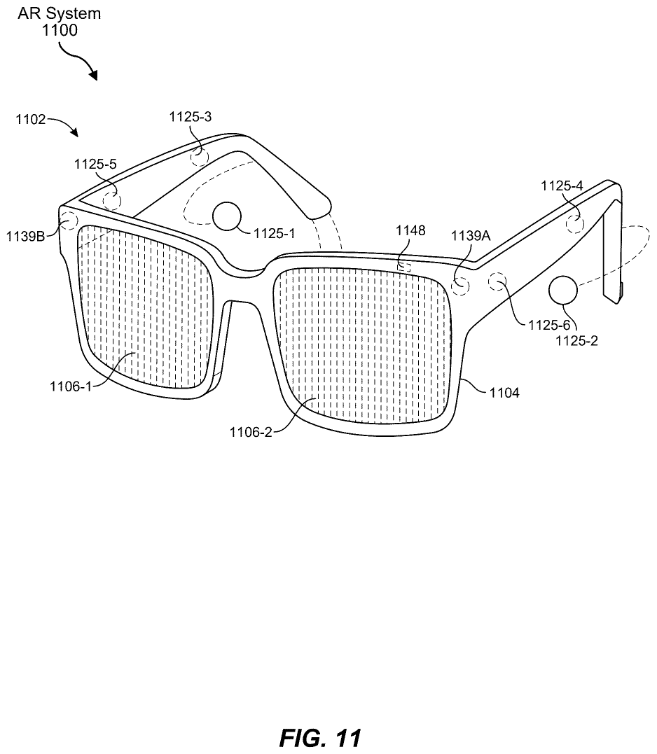

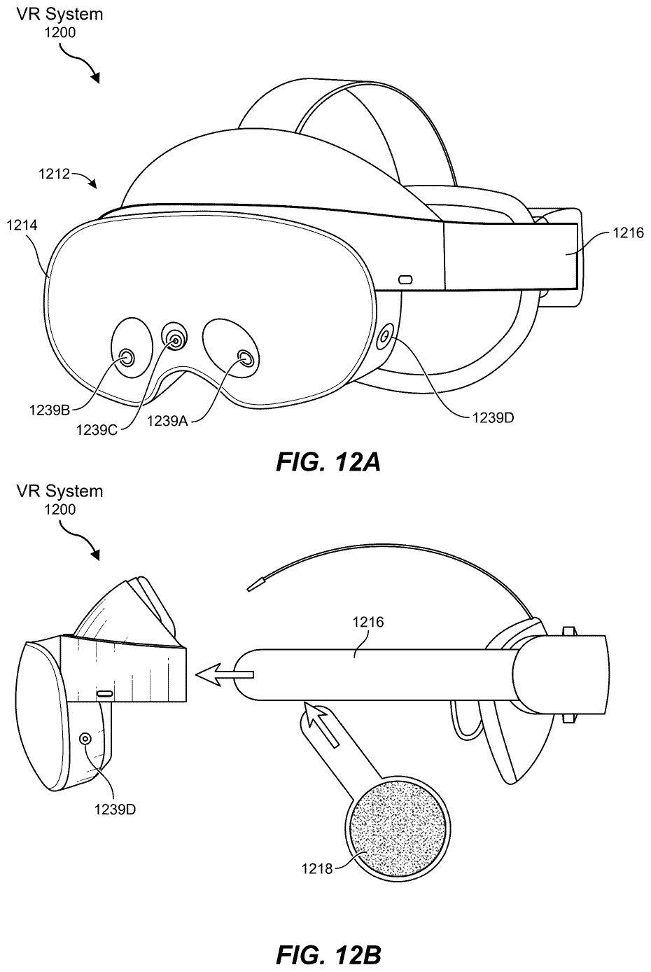

AR systems may be implemented in a variety of different form factors and configurations. Some AR systems may be designed to work without near-eye displays (NEDs). Other AR systems may include a NED that also provides visibility into the real world (such as, e.g., augmented-reality system 1100 in FIG. 11) or that visually immerses a user in an artificial reality (such as, e.g., virtual-reality system 1200 in FIGS. 12A and 12B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

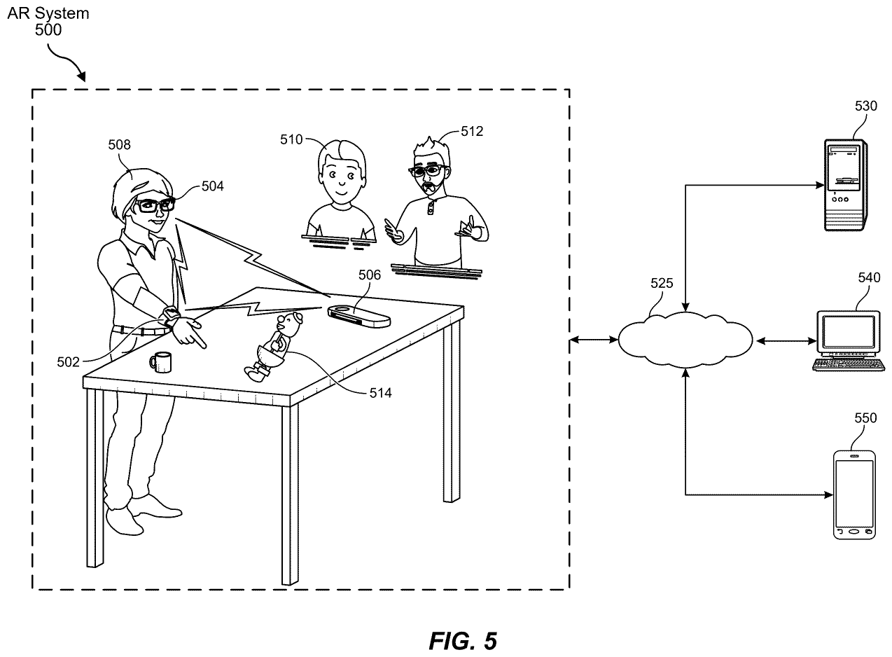

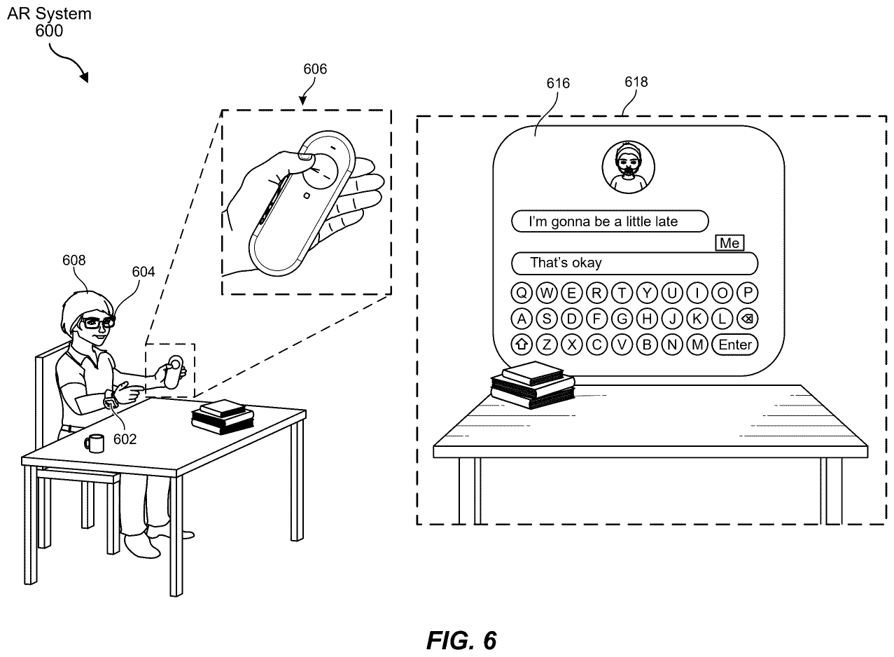

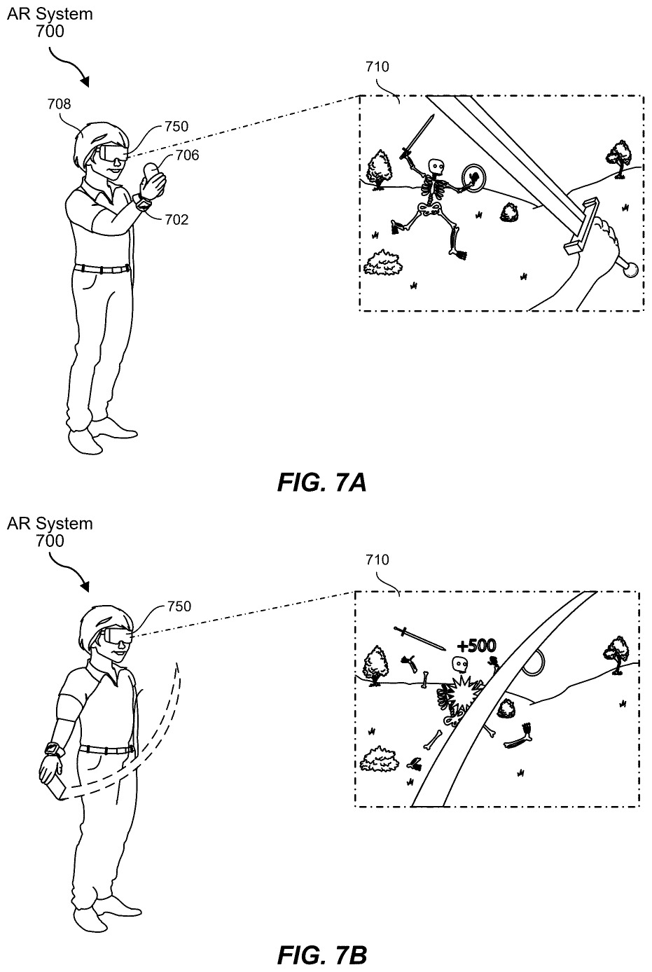

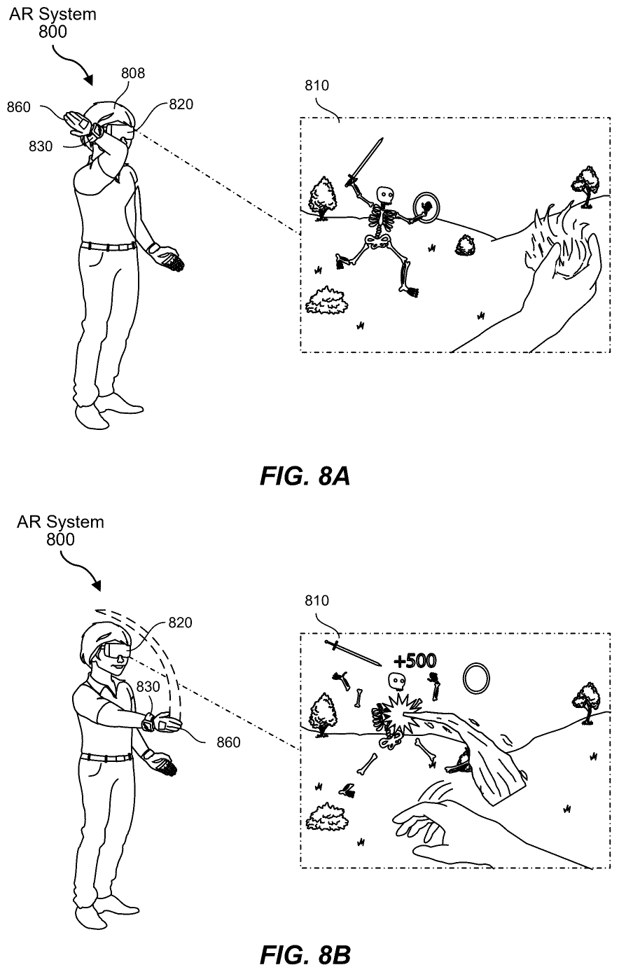

FIGS. 5-8B illustrate example artificial-reality (AR) systems in accordance with some embodiments. FIG. 5 shows a first AR system 500 and first example user interactions using a wrist-wearable device 502, a head-wearable device (e.g., AR glasses 1100), and/or a handheld intermediary processing device (HIPD) 506. FIG. 6 shows a second AR system 600 and second example user interactions using a wrist-wearable device 602, AR glasses 604, and/or an HIPD 606. FIGS. 7A and 7B show a third AR system 700 and third example user 708 interactions using a wrist-wearable device 702, a head-wearable device (e.g., VR headset 750), and/or an HIPD 706. FIGS. 8A and 8B show a fourth AR system 800 and fourth example user 808 interactions using a wrist-wearable device 830, VR headset 820, and/or a haptic device 860 (e.g., wearable gloves).

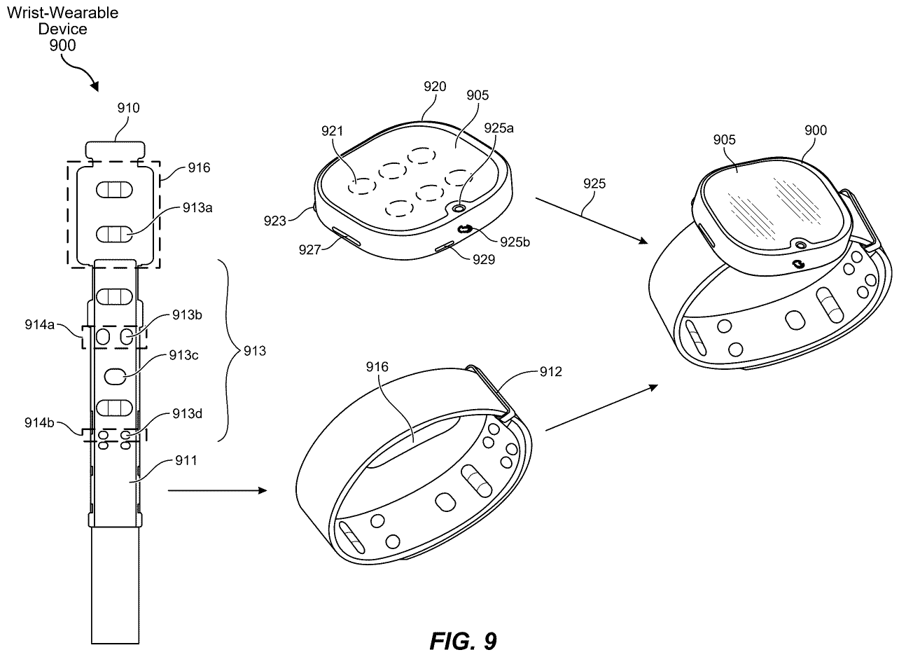

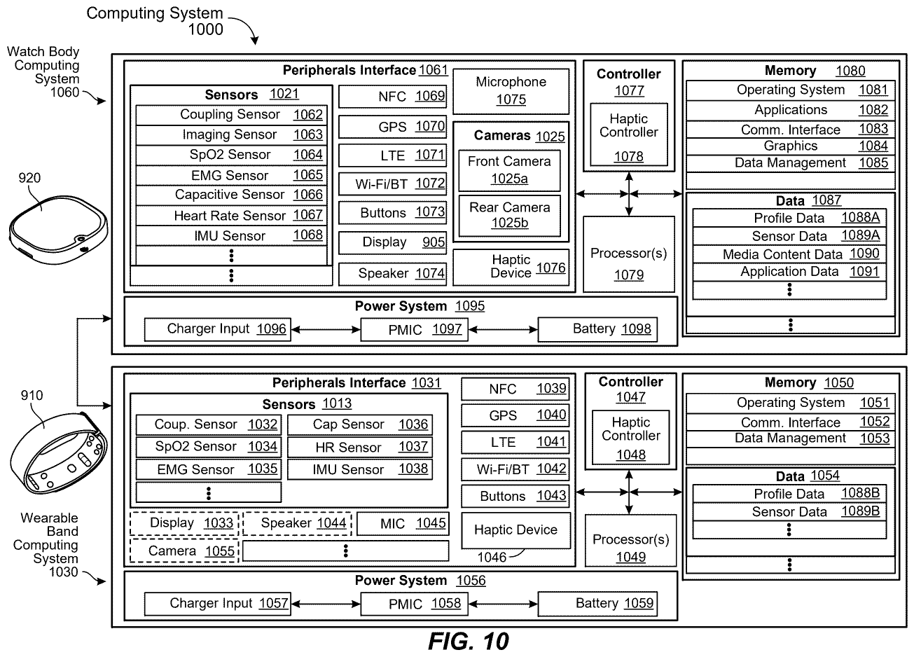

A wrist-wearable device 900, which can be used for wrist-wearable device 502, 602, 702, 830, and one or more of its components, are described below in reference to FIGS. 9 and 10; head-wearable devices 1100 and 1200, which can respectively be used for AR glasses 504, 604 or VR headset 750, 820, and their one or more components are described below in reference to FIGS. 11-13.

Referring to FIG. 5, wrist-wearable device 502, AR glasses 504, and/or HIPD 506 can communicatively couple via a network 525 (e.g., cellular, near field, Wi-Fi, personal area network, wireless LAN, etc.). Additionally, wrist-wearable device 502, AR glasses 504, and/or HIPD 506 can also communicatively couple with one or more servers 530, computers 540 (e.g., laptops, computers, etc.), mobile devices 550 (e.g., smartphones, tablets, etc.), and/or other electronic devices via network 525 (e.g., cellular, near field, Wi-Fi, personal area network, wireless LAN, etc.).

In FIG. 5, a user 508 is shown wearing wrist-wearable device 502 and AR glasses 504 and having HIPD 506 on their desk. The wrist-wearable device 502, AR glasses 504, and HIPD 506 facilitate user interaction with an AR environment. In particular, as shown by first AR system 500, wrist-wearable device 502, AR glasses 504, and/or HIPD 506 cause presentation of one or more avatars 510, digital representations of contacts 512, and virtual objects 514. As discussed below, user 508 can interact with one or more avatars 510, digital representations of contacts 512, and virtual objects 514 via wrist-wearable device 502, AR glasses 504, and/or HIPD 506.

User 508 can use any of wrist-wearable device 502, AR glasses 504, and/or HIPD 506 to provide user inputs. For example, user 508 can perform one or more hand gestures that are detected by wrist-wearable device 502 (e.g., using one or more EMG sensors and/or IMUs, described below in reference to FIGS. 9 and 10) and/or AR glasses 504 (e.g., using one or more image sensor or camera, described below in reference to FIGS. 11-10) to provide a user input. Alternatively, or additionally, user 508 can provide a user input via one or more touch surfaces of wrist-wearable device 502, AR glasses 504, HIPD 506, and/or voice commands captured by a microphone of wrist-wearable device 502, AR glasses 504, and/or HIPD 506. In some embodiments, wrist-wearable device 502, AR glasses 504, and/or HIPD 506 include a digital assistant to help user 508 in providing a user input (e.g., completing a sequence of operations, suggesting different operations or commands, providing reminders, confirming a command, etc.). In some embodiments, user 508 can provide a user input via one or more facial gestures and/or facial expressions. For example, cameras of wrist-wearable device 502, AR glasses 504, and/or HIPD 506 can track eyes of user 508 for navigating a user interface.

Wrist-wearable device 502, AR glasses 504, and/or HIPD 506 can operate alone or in conjunction to allow user 508 to interact with the AR environment. In some embodiments, HIPD 506 is configured to operate as a central hub or control center for the wrist-wearable device 502, AR glasses 504, and/or another communicatively coupled device. For example, user 508 can provide an input to interact with the AR environment at any of wrist-wearable device 502, AR glasses 504, and/or HIPD 506, and HIPD 506 can identify one or more back-end and front-end tasks to cause the performance of the requested interaction and distribute instructions to cause the performance of the one or more back-end and front-end tasks at wrist-wearable device 502, AR glasses 504, and/or HIPD 506. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 506 can perform the back-end tasks and provide wrist-wearable device 502 and/or AR glasses 504 operational data corresponding to the performed back-end tasks such that wrist-wearable device 502 and/or AR glasses 504 can perform the front-end tasks. In this way, HIPD 506, which has more computational resources and greater thermal headroom than wrist-wearable device 502 and/or AR glasses 504, performs computationally intensive tasks and reduces the computer resource utilization and/or power usage of wrist-wearable device 502 and/or AR glasses 504.

In the example shown by first AR system 500, HIPD 506 identifies one or more back-end tasks and front-end tasks associated with a user request to initiate an AR video call with one or more other users (represented by avatar 510 and the digital representation of contact 512) and distributes instructions to cause the performance of the one or more back-end tasks and front-end tasks. In particular, HIPD 506 performs back-end tasks for processing and/or rendering image data (and other data) associated with the AR video call and provides operational data associated with the performed back-end tasks to AR glasses 504 such that the AR glasses 504 perform front-end tasks for presenting the AR video call (e.g., presenting avatar 510 and digital representation of contact 512).

In some embodiments, HIPD 506 can operate as a focal or anchor point for causing the presentation of information. This allows user 508 to be generally aware of where information is presented. For example, as shown in first AR system 500, avatar 510 and the digital representation of contact 512 are presented above HIPD 506. In particular, HIPD 506 and AR glasses 504 operate in conjunction to determine a location for presenting avatar 510 and the digital representation of contact 512. In some embodiments, information can be presented a predetermined distance from HIPD 506 (e.g., within 5 meters). For example, as shown in first AR system 500, virtual object 514 is presented on the desk some distance from HIPD 506. Similar to the above example, HIPD 506 and AR glasses 504 can operate in conjunction to determine a location for presenting virtual object 514. Alternatively, in some embodiments, presentation of information is not bound by HIPD 506. More specifically, avatar 510, digital representation of contact 512, and virtual object 514 do not have to be presented within a predetermined distance of HIPD 506.

User inputs provided at wrist-wearable device 502, AR glasses 504, and/or HIPD 506 are coordinated such that the user can use any device to initiate, continue, and/or complete an operation. For example, user 508 can provide a user input to AR glasses 504 to cause AR glasses 504 to present virtual object 514 and, while virtual object 514 is presented by AR glasses 504, user 508 can provide one or more hand gestures via wrist-wearable device 502 to interact and/or manipulate virtual object 514.

FIG. 6 shows a user 608 wearing a wrist-wearable device 602 and AR glasses 604, and holding an HIPD 606. In second AR system 600, the wrist-wearable device 602, AR glasses 604, and/or HIPD 606 are used to receive and/or provide one or more messages to a contact of user 608. In particular, wrist-wearable device 602, AR glasses 604, and/or HIPD 606 detect and coordinate one or more user inputs to initiate a messaging application and prepare a response to a received message via the messaging application.

In some embodiments, user 608 initiates, via a user input, an application on wrist-wearable device 602, AR glasses 604, and/or HIPD 606 that causes the application to initiate on at least one device. For example, in second AR system 600, user 608 performs a hand gesture associated with a command for initiating a messaging application (represented by messaging user interface 616), wrist-wearable device 602 detects the hand gesture and, based on a determination that user 608 is wearing AR glasses 604, causes AR glasses 604 to present a messaging user interface 616 of the messaging application. AR glasses 604 can present messaging user interface 616 to user 608 via its display (e.g., as shown by a field of view 618 of user 608). In some embodiments, the application is initiated and executed on the device (e.g., wrist-wearable device 602, AR glasses 604, and/or HIPD 606) that detects the user input to initiate the application, and the device provides another device operational data to cause the presentation of the messaging application. For example, wrist-wearable device 602 can detect the user input to initiate a messaging application, initiate and run the messaging application, and provide operational data to AR glasses 604 and/or HIPD 606 to cause presentation of the messaging application. Alternatively, the application can be initiated and executed at a device other than the device that detected the user input. For example, wrist-wearable device 602 can detect the hand gesture associated with initiating the messaging application and cause HIPD 606 to run the messaging application and coordinate the presentation of the messaging application.

Further, user 608 can provide a user input provided at wrist-wearable device 602, AR glasses 604, and/or HIPD 606 to continue and/or complete an operation initiated at another device. For example, after initiating the messaging application via wrist-wearable device 602 and while AR glasses 604 present messaging user interface 616, user 608 can provide an input at HIPD 606 to prepare a response (e.g., shown by the swipe gesture performed on HIPD 606). Gestures performed by user 608 on HIPD 606 can be provided and/or displayed on another device. For example, a swipe gestured performed on HIPD 606 is displayed on a virtual keyboard of messaging user interface 616 displayed by AR glasses 604.

In some embodiments, wrist-wearable device 602, AR glasses 604, HIPD 606, and/or any other communicatively coupled device can present one or more notifications to user 608. The notification can be an indication of a new message, an incoming call, an application update, a status update, etc. User 608 can select the notification via wrist-wearable device 602, AR glasses 604, and/or HIPD 606 and can cause presentation of an application or operation associated with the notification on at least one device. For example, user 608 can receive a notification that a message was received at wrist-wearable device 602, AR glasses 604, HIPD 606, and/or any other communicatively coupled device and can then provide a user input at wrist-wearable device 602, AR glasses 604, and/or HIPD 606 to review the notification, and the device detecting the user input can cause an application associated with the notification to be initiated and/or presented at wrist-wearable device 602, AR glasses 604, and/or HIPD 606.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 604 can present to user 608 game application data, and HIPD 606 can be used as a controller to provide inputs to the game. Similarly, user 608 can use wrist-wearable device 602 to initiate a camera of AR glasses 604, and user 608 can use wrist-wearable device 602, AR glasses 604, and/or HIPD 606 to manipulate the image capture (e.g., zoom in or out, apply filters, etc.) and capture image data.

Users may interact with the devices disclosed herein in a variety of ways. For example, as shown in FIGS. 7A and 7B, a user 708 may interact with an AR system 700 by donning a VR headset 750 while holding HIPD 706 and wearing wrist-wearable device 702. In this example, AR system 700 may enable a user to interact with a game 710 by swiping their arm. One or more of VR headset 750, HIPD 706, and wrist-wearable device 702 may detect this gesture and, in response, may display a sword strike in game 710. Similarly, in FIGS. 8A and 8B, a user 808 may interact with an AR system 800 by donning a VR headset 820 while wearing haptic device 860 and wrist-wearable device 830. In this example, AR system 800 may enable a user to interact with a game 810 by swiping their arm. One or more of VR headset 820, haptic device 860, and wrist-wearable device 830 may detect this gesture and, in response, may display a spell being cast in game 710.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 9 and 10 illustrate an example wrist-wearable device 900 and an example computer system 1000, in accordance with some embodiments. Wrist-wearable device 900 is an instance of wearable device 502 described in FIG. 5 herein, such that the wearable device 502 should be understood to have the features of the wrist-wearable device 900 and vice versa. FIG. 10 illustrates components of the wrist-wearable device 900, which can be used individually or in combination, including combinations that include other electronic devices and/or electronic components.

FIG. 9 shows a wearable band 910 and a watch body 920 (or capsule) being coupled, as discussed below, to form wrist-wearable device 900. Wrist-wearable device 900 can perform various functions and/or operations associated with navigating through user interfaces and selectively opening applications as well as the functions and/or operations described above with reference to FIGS. 5-8B.

As will be described in more detail below, operations executed by wrist-wearable device 900 can include (i) presenting content to a user (e.g., displaying visual content via a display 905), (ii) detecting (e.g., sensing) user input (e.g., sensing a touch on peripheral button 923 and/or at a touch screen of the display 905, a hand gesture detected by sensors (e.g., biopotential sensors)), (iii) sensing biometric data (e.g., neuromuscular signals, heart rate, temperature, sleep, etc.) via one or more sensors 913, messaging (e.g., text, speech, video, etc.); image capture via one or more imaging devices or cameras 925, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 920, independently in wearable band 910, and/or via an electronic communication between watch body 920 and wearable band 910. In some embodiments, functions can be executed on wrist-wearable device 900 while an AR environment is being presented (e.g., via one of AR systems 500 to 800). The wearable devices described herein can also be used with other types of AR environments.

Wearable band 910 can be configured to be worn by a user such that an inner surface of a wearable structure 911 of wearable band 910 is in contact with the user's skin. In this example, when worn by a user, sensors 913 may contact the user's skin. In some examples, one or more of sensors 913 can sense biometric data such as a user's heart rate, a saturated oxygen level, temperature, sweat level, neuromuscular signals, or a combination thereof. One or more of sensors 913 can also sense data about a user's environment including a user's motion, altitude, location, orientation, gait, acceleration, position, or a combination thereof. In some embodiment, one or more of sensors 913 can be configured to track a position and/or motion of wearable band 910. One or more of sensors 913 can include any of the sensors defined above and/or discussed below with respect to FIG. 9.

One or more of sensors 913 can be distributed on an inside and/or an outside surface of wearable band 910. In some embodiments, one or more of sensors 913 are uniformly spaced along wearable band 910. Alternatively, in some embodiments, one or more of sensors 913 are positioned at distinct points along wearable band 910. As shown in FIG. 9, one or more of sensors 913 can be the same or distinct. For example, in some embodiments, one or more of sensors 913 can be shaped as a pill (e.g., sensor 913a), an oval, a circle a square, an oblong (e.g., sensor 913c) and/or any other shape that maintains contact with the user's skin (e.g., such that neuromuscular signal and/or other biometric data can be accurately measured at the user's skin). In some embodiments, one or more sensors of 913 are aligned to form pairs of sensors (e.g., for sensing neuromuscular signals based on differential sensing within each respective sensor). For example, sensor 913b may be aligned with an adjacent sensor to form sensor pair 914a and sensor 913d may be aligned with an adjacent sensor to form sensor pair 914b. In some embodiments, wearable band 910 does not have a sensor pair. Alternatively, in some embodiments, wearable band 910 has a predetermined number of sensor pairs (one pair of sensors, three pairs of sensors, four pairs of sensors, six pairs of sensors, sixteen pairs of sensors, etc.).

Wearable band 910 can include any suitable number of sensors 913. In some embodiments, the number and arrangement of sensors 913 depends on the particular application for which wearable band 910 is used. For instance, wearable band 910 can be configured as an armband, wristband, or chest-band that include a plurality of sensors 913 with different number of sensors 913, a variety of types of individual sensors with the plurality of sensors 913, and different arrangements for each use case, such as medical use cases as compared to gaming or general day-to-day use cases.

In accordance with some embodiments, wearable band 910 further includes an electrical ground electrode and a shielding electrode. The electrical ground and shielding electrodes, like the sensors 913, can be distributed on the inside surface of the wearable band 910 such that they contact a portion of the user's skin. For example, the electrical ground and shielding electrodes can be at an inside surface of a coupling mechanism 916 or an inside surface of a wearable structure 911. The electrical ground and shielding electrodes can be formed and/or use the same components as sensors 913. In some embodiments, wearable band 910 includes more than one electrical ground electrode and more than one shielding electrode.

Sensors 913 can be formed as part of wearable structure 911 of wearable band 910. In some embodiments, sensors 913 are flush or substantially flush with wearable structure 911 such that they do not extend beyond the surface of wearable structure 911. While flush with wearable structure 911, sensors 913 are still configured to contact the user's skin (e.g., via a skin-contacting surface). Alternatively, in some embodiments, sensors 913 extend beyond wearable structure 911 a predetermined distance (e.g., 0.1-2 mm) to make contact and depress into the user's skin. In some embodiment, sensors 913 are coupled to an actuator (not shown) configured to adjust an extension height (e.g., a distance from the surface of wearable structure 911) of sensors 913 such that sensors 913 make contact and depress into the user's skin. In some embodiments, the actuators adjust the extension height between 0.01 mm-1.2 mm. This may allow a the user to customize the positioning of sensors 913 to improve the overall comfort of the wearable band 910 when worn while still allowing sensors 913 to contact the user's skin. In some embodiments, sensors 913 are indistinguishable from wearable structure 911 when worn by the user.

Wearable structure 911 can be formed of an elastic material, elastomers, etc., configured to be stretched and fitted to be worn by the user. In some embodiments, wearable structure 911 is a textile or woven fabric. As described above, sensors 913 can be formed as part of a wearable structure 911. For example, sensors 913 can be molded into the wearable structure 911, be integrated into a woven fabric (e.g., sensors 913 can be sewn into the fabric and mimic the pliability of fabric and can and/or be constructed from a series woven strands of fabric).

Wearable structure 911 can include flexible electronic connectors that interconnect sensors 913, the electronic circuitry, and/or other electronic components (described below in reference to FIG. 10) that are enclosed in wearable band 910. In some embodiments, the flexible electronic connectors are configured to interconnect sensors 913, the electronic circuitry, and/or other electronic components of wearable band 910 with respective sensors and/or other electronic components of another electronic device (e.g., watch body 920). The flexible electronic connectors are configured to move with wearable structure 911 such that the user adjustment to wearable structure 911 (e.g., resizing, pulling, folding, etc.) does not stress or strain the electrical coupling of components of wearable band 910.

As described above, wearable band 910 is configured to be worn by a user. In particular, wearable band 910 can be shaped or otherwise manipulated to be worn by a user. For example, wearable band 910 can be shaped to have a substantially circular shape such that it can be configured to be worn on the user's lower arm or wrist. Alternatively, wearable band 910 can be shaped to be worn on another body part of the user, such as the user's upper arm (e.g., around a bicep), forearm, chest, legs, etc. Wearable band 910 can include a retaining mechanism 912 (e.g., a buckle, a hook and loop fastener, etc.) for securing wearable band 910 to the user's wrist or other body part. While wearable band 910 is worn by the user, sensors 913 sense data (referred to as sensor data) from the user's skin. In some examples, sensors 913 of wearable band 910 obtain (e.g., sense and record) neuromuscular signals.

The sensed data (e.g., sensed neuromuscular signals) can be used to detect and/or determine the user's intention to perform certain motor actions. In some examples, sensors 913 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 905 of wrist-wearable device 900 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 913 can be used to provide a user with an enhanced interaction with a physical object (e.g., devices communicatively coupled with wearable band 910) and/or a virtual object in an artificial-reality application generated by an artificial-reality system (e.g., user interface objects presented on the display 905, or another computing device (e.g., a smartphone)).

In some embodiments, wearable band 910 includes one or more haptic devices 1046 (e.g., a vibratory haptic actuator) that are configured to provide haptic feedback (e.g., a cutaneous and/or kinesthetic sensation, etc.) to the user's skin. Sensors 913 and/or haptic devices 1046 (shown in FIG. 10) can be configured to operate in conjunction with multiple applications including, without limitation, health monitoring, social media, games, and artificial reality (e.g., the applications associated with artificial reality).

Wearable band 910 can also include coupling mechanism 916 for detachably coupling a capsule (e.g., a computing unit) or watch body 920 (via a coupling surface of the watch body 920) to wearable band 910. For example, a cradle or a shape of coupling mechanism 916 can correspond to shape of watch body 920 of wrist-wearable device 900. In particular, coupling mechanism 916 can be configured to receive a coupling surface proximate to the bottom side of watch body 920 (e.g., a side opposite to a front side of watch body 920 where display 905 is located), such that a user can push watch body 920 downward into coupling mechanism 916 to attach watch body 920 to coupling mechanism 916. In some embodiments, coupling mechanism 916 can be configured to receive a top side of the watch body 920 (e.g., a side proximate to the front side of watch body 920 where display 905 is located) that is pushed upward into the cradle, as opposed to being pushed downward into coupling mechanism 916. In some embodiments, coupling mechanism 916 is an integrated component of wearable band 910 such that wearable band 910 and coupling mechanism 916 are a single unitary structure. In some embodiments, coupling mechanism 916 is a type of frame or shell that allows watch body 920 coupling surface to be retained within or on wearable band 910 coupling mechanism 916 (e.g., a cradle, a tracker band, a support base, a clasp, etc.).

Coupling mechanism 916 can allow for watch body 920 to be detachably coupled to the wearable band 910 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 920 to wearable band 910 and to decouple the watch body 920 from the wearable band 910. For example, a user can twist, slide, turn, push, pull, or rotate watch body 920 relative to wearable band 910, or a combination thereof, to attach watch body 920 to wearable band 910 and to detach watch body 920 from wearable band 910. Alternatively, as discussed below, in some embodiments, the watch body 920 can be decoupled from the wearable band 910 by actuation of a release mechanism 929.

Wearable band 910 can be coupled with watch body 920 to increase the functionality of wearable band 910 (e.g., converting wearable band 910 into wrist-wearable device 900, adding an additional computing unit and/or battery to increase computational resources and/or a battery life of wearable band 910, adding additional sensors to improve sensed data, etc.). As described above, wearable band 910 and coupling mechanism 916 are configured to operate independently (e.g., execute functions independently) from watch body 920. For example, coupling mechanism 916 can include one or more sensors 913 that contact a user's skin when wearable band 910 is worn by the user, with or without watch body 920 and can provide sensor data for determining control commands.

A user can detach watch body 920 from wearable band 910 to reduce the encumbrance of wrist-wearable device 900 to the user. For embodiments in which watch body 920 is removable, watch body 920 can be referred to as a removable structure, such that in these embodiments wrist-wearable device 900 includes a wearable portion (e.g., wearable band 910) and a removable structure (e.g., watch body 920).

Turning to watch body 920, in some examples watch body 920 can have a substantially rectangular or circular shape. Watch body 920 is configured to be worn by the user on their wrist or on another body part. More specifically, watch body 920 is sized to be easily carried by the user, attached on a portion of the user's clothing, and/or coupled to wearable band 910 (forming the wrist-wearable device 900). As described above, watch body 920 can have a shape corresponding to coupling mechanism 916 of wearable band 910. In some embodiments, watch body 920 includes a single release mechanism 929 or multiple release mechanisms (e.g., two release mechanisms 929 positioned on opposing sides of watch body 920, such as spring-loaded buttons) for decoupling watch body 920 from wearable band 910. Release mechanism 929 can include, without limitation, a button, a knob, a plunger, a handle, a lever, a fastener, a clasp, a dial, a latch, or a combination thereof.

A user can actuate release mechanism 929 by pushing, turning, lifting, depressing, shifting, or performing other actions on release mechanism 929. Actuation of release mechanism 929 can release (e.g., decouple) watch body 920 from coupling mechanism 916 of wearable band 910, allowing the user to use watch body 920 independently from wearable band 910 and vice versa. For example, decoupling watch body 920 from wearable band 910 can allow a user to capture images using rear-facing camera 925b. Although release mechanism 929 is shown positioned at a corner of watch body 920, release mechanism 929 can be positioned anywhere on watch body 920 that is convenient for the user to actuate. In addition, in some embodiments, wearable band 910 can also include a respective release mechanism for decoupling watch body 920 from coupling mechanism 916. In some embodiments, release mechanism 929 is optional and watch body 920 can be decoupled from coupling mechanism 916 as described above (e.g., via twisting, rotating, etc.).

Watch body 920 can include one or more peripheral buttons 923 and 927 for performing various operations at watch body 920. For example, peripheral buttons 923 and 927 can be used to turn on or wake (e.g., transition from a sleep state to an active state) display 905, unlock watch body 920, increase or decrease a volume, increase or decrease a brightness, interact with one or more applications, interact with one or more user interfaces, etc. Additionally or alternatively, in some embodiments, display 905 operates as a touch screen and allows the user to provide one or more inputs for interacting with watch body 920.

In some embodiments, watch body 920 includes one or more sensors 921. Sensors 921 of watch body 920 can be the same or distinct from sensors 913 of wearable band 910. Sensors 921 of watch body 920 can be distributed on an inside and/or an outside surface of watch body 920. In some embodiments, sensors 921 are configured to contact a user's skin when watch body 920 is worn by the user. For example, sensors 921 can be placed on the bottom side of watch body 920 and coupling mechanism 916 can be a cradle with an opening that allows the bottom side of watch body 920 to directly contact the user's skin. Alternatively, in some embodiments, watch body 920 does not include sensors that are configured to contact the user's skin (e.g., including sensors internal and/or external to the watch body 920 that are configured to sense data of watch body 920 and the surrounding environment). In some embodiments, sensors 921 are configured to track a position and/or motion of watch body 920.

Watch body 920 and wearable band 910 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 920 and wearable band 910 can share data sensed by sensors 913 and 921, as well as application and device specific information (e.g., active and/or available applications, output devices (e.g., displays, speakers, etc.), input devices (e.g., touch screens, microphones, imaging sensors, etc.).

In some embodiments, watch body 920 can include, without limitation, a front-facing camera 925a and/or a rear-facing camera 925b, sensors 921 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1063), a touch sensor, a sweat sensor, etc.). In some embodiments, watch body 920 can include one or more haptic devices 1076 (e.g., a vibratory haptic actuator) that is configured to provide haptic feedback (e.g., a cutaneous and/or kinesthetic sensation, etc.) to the user. Sensors 1021 and/or haptic device 1076 can also be configured to operate in conjunction with multiple applications including, without limitation, health monitoring applications, social media applications, game applications, and artificial reality applications (e.g., the applications associated with artificial reality).

As described above, watch body 920 and wearable band 910, when coupled, can form wrist-wearable device 900. When coupled, watch body 920 and wearable band 910 may operate as a single device to execute functions (operations, detections, communications, etc.) described herein. In some embodiments, each device may be provided with particular instructions for performing the one or more operations of wrist-wearable device 900. For example, in accordance with a determination that watch body 920 does not include neuromuscular signal sensors, wearable band 910 can include alternative instructions for performing associated instructions (e.g., providing sensed neuromuscular signal data to watch body 920 via a different electronic device). Operations of wrist-wearable device 900 can be performed by watch body 920 alone or in conjunction with wearable band 910 (e.g., via respective processors and/or hardware components) and vice versa. In some embodiments, operations of wrist-wearable device 900, watch body 920, and/or wearable band 910 can be performed in conjunction with one or more processors and/or hardware components.

As described below with reference to the block diagram of FIG. 10, wearable band 910 and/or watch body 920 can each include independent resources required to independently execute functions. For example, wearable band 910 and/or watch body 920 can each include a power source (e.g., a battery), a memory, data storage, a processor (e.g., a central processing unit (CPU)), communications, a light source, and/or input/output devices.

FIG. 10 shows block diagrams of a computing system 1030 corresponding to wearable band 910 and a computing system 1060 corresponding to watch body 920 according to some embodiments. Computing system 1000 of wrist-wearable device 900 may include a combination of components of wearable band computing system 1030 and watch body computing system 1060, in accordance with some embodiments.

Watch body 920 and/or wearable band 910 can include one or more components shown in watch body computing system 1060. In some embodiments, a single integrated circuit may include all or a substantial portion of the components of watch body computing system 1060 included in a single integrated circuit. Alternatively, in some embodiments, components of the watch body computing system 1060 may be included in a plurality of integrated circuits that are communicatively coupled. In some embodiments, watch body computing system 1060 may be configured to couple (e.g., via a wired or wireless connection) with wearable band computing system 1030, which may allow the computing systems to share components, distribute tasks, and/or perform other operations described herein (individually or as a single device).

Watch body computing system 1060 can include one or more processors 1079, a controller 1077, a peripherals interface 1061, a power system 1095, and memory (e.g., a memory 1080).

Power system 1095 can include a charger input 1096, a power-management integrated circuit (PMIC) 1097, and a battery 1098. In some embodiments, a watch body 920 and a wearable band 910 can have respective batteries (e.g., battery 1098 and 1059) and can share power with each other. Watch body 920 and wearable band 910 can receive a charge using a variety of techniques. In some embodiments, watch body 920 and wearable band 910 can use a wired charging assembly (e.g., power cords) to receive the charge. Alternatively, or in addition, watch body 920 and/or wearable band 910 can be configured for wireless charging. For example, a portable charging device can be designed to mate with a portion of watch body 920 and/or wearable band 910 and wirelessly deliver usable power to battery 1098 of watch body 920 and/or battery 1059 of wearable band 910. Watch body 920 and wearable band 910 can have independent power systems (e.g., power system 1095 and 1056, respectively) to enable each to operate independently. Watch body 920 and wearable band 910 can also share power (e.g., one can charge the other) via respective PMICs (e.g., PMICs 1097 and 1058) and charger inputs (e.g., 1057 and 1096) that can share power over power and ground conductors and/or over wireless charging antennas.

In some embodiments, peripherals interface 1061 can include one or more sensors 1021. Sensors 1021 can include one or more coupling sensors 1062 for detecting when watch body 920 is coupled with another electronic device (e.g., a wearable band 910). Sensors 1021 can include one or more imaging sensors 1063 (e.g., one or more of cameras 1025, and/or separate imaging sensors 1063 (e.g., thermal-imaging sensors)). In some embodiments, sensors 1021 can include one or more SpO2 sensors 1064. In some embodiments, sensors 1021 can include one or more biopotential-signal sensors (e.g., EMG sensors 1065, which may be disposed on an interior, user-facing portion of watch body 920 and/or wearable band 910). In some embodiments, sensors 1021 may include one or more capacitive sensors 1066. In some embodiments, sensors 1021 may include one or more heart rate sensors 1067. In some embodiments, sensors 1021 may include one or more IMU sensors 1068. In some embodiments, one or more IMU sensors 1068 can be configured to detect movement of a user's hand or other location where watch body 920 is placed or held.

In some embodiments, one or more of sensors 1021 may provide an example human-machine interface. For example, a set of neuromuscular sensors, such as EMG sensors 1065, may be arranged circumferentially around wearable band 910 with an interior surface of EMG sensors 1065 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 910 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1079. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1065 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1061 includes a near-field communication (NFC) component 1069, a global-position system (GPS) component 1070, a long-term evolution (LTE) component 1071, and/or a Wi-Fi and/or Bluetooth communication component 1072. In some embodiments, peripherals interface 1061 includes one or more buttons 1073 (e.g., peripheral buttons 923 and 927 in FIG. 9), which, when selected by a user, cause operation to be performed at watch body 920. In some embodiments, the peripherals interface 1061 includes one or more indicators, such as a light emitting diode (LED), to provide a user with visual indicators (e.g., message received, low battery, active microphone and/or camera, etc.).

Watch body 920 can include at least one display 905 for displaying visual representations of information or data to a user, including user-interface elements and/or three-dimensional virtual objects. The display can also include a touch screen for inputting user inputs, such as touch gestures, swipe gestures, and the like. Watch body 920 can include at least one speaker 1074 and at least one microphone 1075 for providing audio signals to the user and receiving audio input from the user. The user can provide user inputs through microphone 1075 and can also receive audio output from speaker 1074 as part of a haptic event provided by haptic controller 1078. Watch body 920 can include at least one camera 1025, including a front camera 1025a and a rear camera 1025b. Cameras 1025 can include ultra-wide-angle cameras, wide angle cameras, fish-eye cameras, spherical cameras, telephoto cameras, depth-sensing cameras, or other types of cameras.

Watch body computing system 1060 can include one or more haptic controllers 1078 and associated componentry (e.g., haptic devices 1076) for providing haptic events at watch body 920 (e.g., a vibrating sensation or audio output in response to an event at the watch body 920). Haptic controllers 1078 can communicate with one or more haptic devices 1076, such as electroacoustic devices, including a speaker of the one or more speakers 1074 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1078 can provide haptic events to that are capable of being sensed by a user of watch body 920. In some embodiments, one or more haptic controllers 1078 can receive input signals from an application of applications 1082.

In some embodiments, wearable band computing system 1030 and/or watch body computing system 1060 can include memory 1080, which can be controlled by one or more memory controllers of controllers 1077. In some embodiments, software components stored in memory 1080 include one or more applications 1082 configured to perform operations at the watch body 920. In some embodiments, one or more applications 1082 may include games, word processors, messaging applications, calling applications, web browsers, social media applications, media streaming applications, financial applications, calendars, clocks, etc. In some embodiments, software components stored in memory 1080 include one or more communication interface modules 1083 as defined above. In some embodiments, software components stored in memory 1080 include one or more graphics modules 1084 for rendering, encoding, and/or decoding audio and/or visual data and one or more data management modules 1085 for collecting, organizing, and/or providing access to data 1087 stored in memory 1080. In some embodiments, one or more of applications 1082 and/or one or more modules can work in conjunction with one another to perform various tasks at the watch body 920.

In some embodiments, software components stored in memory 1080 can include one or more operating systems 1081 (e.g., a Linux-based operating system, an Android operating system, etc.). Memory 1080 can also include data 1087. Data 1087 can include profile data 1088A, sensor data 1089A, media content data 1090, and application data 1091.

It should be appreciated that watch body computing system 1060 is an example of a computing system within watch body 920, and that watch body 920 can have more or fewer components than shown in watch body computing system 1060, can combine two or more components, and/or can have a different configuration and/or arrangement of the components. The various components shown in watch body computing system 1060 are implemented in hardware, software, firmware, or a combination thereof, including one or more signal processing and/or application-specific integrated circuits.

Turning to the wearable band computing system 1030, one or more components that can be included in wearable band 910 are shown. Wearable band computing system 1030 can include more or fewer components than shown in watch body computing system 1060, can combine two or more components, and/or can have a different configuration and/or arrangement of some or all of the components. In some embodiments, all, or a substantial portion of the components of wearable band computing system 1030 are included in a single integrated circuit. Alternatively, in some embodiments, components of wearable band computing system 1030 are included in a plurality of integrated circuits that are communicatively coupled. As described above, in some embodiments, wearable band computing system 1030 is configured to couple (e.g., via a wired or wireless connection) with watch body computing system 1060, which allows the computing systems to share components, distribute tasks, and/or perform other operations described herein (individually or as a single device).

Wearable band computing system 1030, similar to watch body computing system 1060, can include one or more processors 1049, one or more controllers 1047 (including one or more haptics controllers 1048), a peripherals interface 1031 that can includes one or more sensors 1013 and other peripheral devices, a power source (e.g., a power system 1056), and memory (e.g., a memory 1050) that includes an operating system (e.g., an operating system 1051), data (e.g., data 1054 including profile data 1088B, sensor data 1089B, etc.), and one or more modules (e.g., a communications interface module 1052, a data management module 1053, etc.).

One or more of sensors 1013 can be analogous to sensors 1021 of watch body computing system 1060. For example, sensors 1013 can include one or more coupling sensors 1032, one or more SpO2 sensors 1034, one or more EMG sensors 1035, one or more capacitive sensors 1036, one or more heart rate sensors 1037, and one or more IMU sensors 1038.

Peripherals interface 1031 can also include other components analogous to those included in peripherals interface 1061 of watch body computing system 1060, including an NFC component 1039, a GPS component 1040, an LTE component 1041, a Wi-Fi and/or Bluetooth communication component 1042, and/or one or more haptic devices 1046 as described above in reference to peripherals interface 1061. In some embodiments, peripherals interface 1031 includes one or more buttons 1043, a display 1033, a speaker 1044, a microphone 1045, and a camera 1055. In some embodiments, peripherals interface 1031 includes one or more indicators, such as an LED.

It should be appreciated that wearable band computing system 1030 is an example of a computing system within wearable band 910, and that wearable band 910 can have more or fewer components than shown in wearable band computing system 1030, combine two or more components, and/or have a different configuration and/or arrangement of the components. The various components shown in wearable band computing system 1030 can be implemented in one or more of a combination of hardware, software, or firmware, including one or more signal processing and/or application-specific integrated circuits.

Wrist-wearable device 900 with respect to FIG. 9 is an example of wearable band 910 and watch body 920 coupled together, so wrist-wearable device 900 will be understood to include the components shown and described for wearable band computing system 1030 and watch body computing system 1060. In some embodiments, wrist-wearable device 900 has a split architecture (e.g., a split mechanical architecture, a split electrical architecture, etc.) between watch body 920 and wearable band 910. In other words, all of the components shown in wearable band computing system 1030 and watch body computing system 1060 can be housed or otherwise disposed in a combined wrist-wearable device 900 or within individual components of watch body 920, wearable band 910, and/or portions thereof (e.g., a coupling mechanism 916 of wearable band 910).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 900 can be used in conjunction with a head-wearable device (e.g., AR glasses 1100 and VR system 1210) and/or an HIPD, and wrist-wearable device 900 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1100 and VR headset 1210.

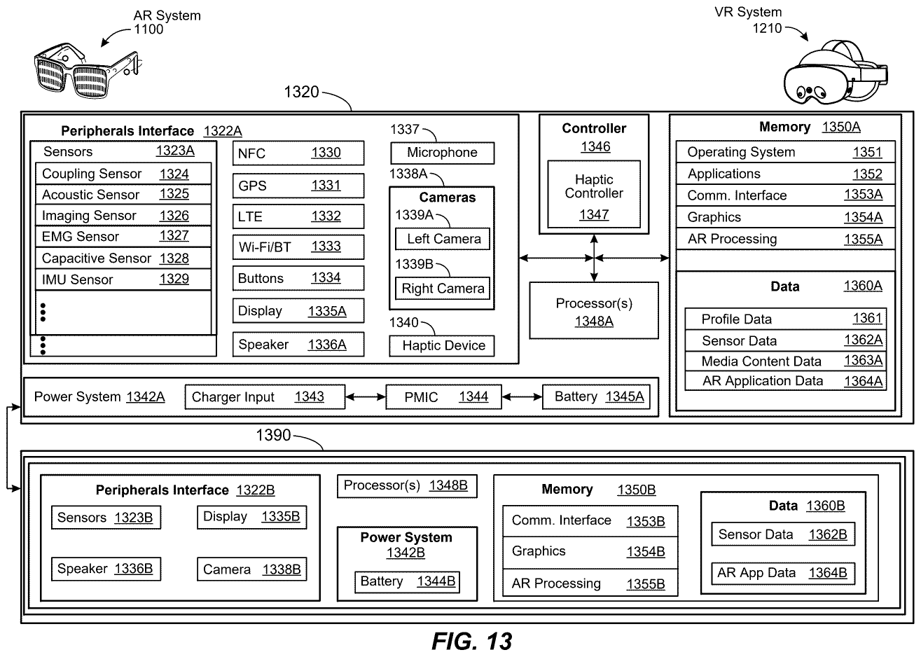

FIGS. 11 to 13 show example artificial-reality systems, which can be used as or in connection with wrist-wearable device 900. In some embodiments, AR system 1100 includes an eyewear device 1102, as shown in FIG. 11. In some embodiments, VR system 1210 includes a head-mounted display (HMD) 1212, as shown in FIGS. 12A and 12B. In some embodiments, AR system 1100 and VR system 1210 can include one or more analogous components (e.g., components for presenting interactive artificial-reality environments, such as processors, memory, and/or presentation devices, including one or more displays and/or one or more waveguides), some of which are described in more detail with respect to FIG. 13. As described herein, a head-wearable device can include components of eyewear device 1102 and/or head-mounted display 1212. Some embodiments of head-wearable devices do not include any displays, including any of the displays described with respect to AR system 1100 and/or VR system 1210. While the example artificial-reality systems are respectively described herein as AR system 1100 and VR system 1210, either or both of the example AR systems described herein can be configured to present fully-immersive virtual-reality scenes presented in substantially all of a user's field of view or subtler augmented-reality scenes that are presented within a portion, less than all, of the user's field of view.

FIG. 11 show an example visual depiction of AR system 1100, including an eyewear device 1102 (which may also be described herein as augmented-reality glasses, and/or smart glasses). AR system 1100 can include additional electronic components that are not shown in FIG. 11, such as a wearable accessory device and/or an intermediary processing device, in electronic communication or otherwise configured to be used in conjunction with the eyewear device 1102. In some embodiments, the wearable accessory device and/or the intermediary processing device may be configured to couple with eyewear device 1102 via a coupling mechanism in electronic communication with a coupling sensor 1324 (FIG. 13), where coupling sensor 1324 can detect when an electronic device becomes physically or electronically coupled with eyewear device 1102. In some embodiments, eyewear device 1102 can be configured to couple to a housing 1390 (FIG. 13), which may include one or more additional coupling mechanisms configured to couple with additional accessory devices. The components shown in FIG. 11 can be implemented in hardware, software, firmware, or a combination thereof, including one or more signal-processing components and/or application-specific integrated circuits (ASICs).

Eyewear device 1102 includes mechanical glasses components, including a frame 1104 configured to hold one or more lenses (e.g., one or both lenses 1106-1 and 1106-2). One of ordinary skill in the art will appreciate that eyewear device 1102 can include additional mechanical components, such as hinges configured to allow portions of frame 1104 of eyewear device 1102 to be folded and unfolded, a bridge configured to span the gap between lenses 1106-1 and 1106-2 and rest on the user's nose, nose pads configured to rest on the bridge of the nose and provide support for eyewear device 1102, earpieces configured to rest on the user's ears and provide additional support for eyewear device 1102, temple arms configured to extend from the hinges to the earpieces of eyewear device 1102, and the like. One of ordinary skill in the art will further appreciate that some examples of AR system 1100 can include none of the mechanical components described herein. For example, smart contact lenses configured to present artificial reality to users may not include any components of eyewear device 1102.

Eyewear device 1102 includes electronic components, many of which will be described in more detail below with respect to FIG. 10. Some example electronic components are illustrated in FIG. 11, including acoustic sensors 1125-1, 1125-2, 1125-3, 1125-4, 1125-5, and 1125-6, which can be distributed along a substantial portion of the frame 1104 of eyewear device 1102. Eyewear device 1102 also includes a left camera 1139A and a right camera 1139B, which are located on different sides of the frame 1104. Eyewear device 1102 also includes a processor 1148 (or any other suitable type or form of integrated circuit) that is embedded into a portion of the frame 1104.

FIGS. 12A and 12B show a VR system 1210 that includes a head-mounted display (HMD) 1212 (e.g., also referred to herein as an artificial-reality headset, a head-wearable device, a VR headset, etc.), in accordance with some embodiments. As noted, some artificial-reality systems (e.g., AR system 1100) may, instead of blending an artificial reality with actual reality, substantially replace one or more of a user's visual and/or other sensory perceptions of the real world with a virtual experience (e.g., AR systems 700 and 800).

HMD 1212 includes a front body 1214 and a frame 1216 (e.g., a strap or band) shaped to fit around a user's head. In some embodiments, front body 1214 and/or frame 1216 include one or more electronic elements for facilitating presentation of and/or interactions with an AR and/or VR system (e.g., displays, IMUs, tracking emitter or detectors). In some embodiments, HMD 1212 includes output audio transducers (e.g., an audio transducer 1218), as shown in FIG. 12B. In some embodiments, one or more components, such as the output audio transducer(s) 1218 and frame 1216, can be configured to attach and detach (e.g., are detachably attachable) to HMD 1212 (e.g., a portion or all of frame 1216, and/or audio transducer 1218), as shown in FIG. 12B. In some embodiments, coupling a detachable component to HMD 1212 causes the detachable component to come into electronic communication with HMD 1212.

FIGS. 12A and 12B also show that VR system 1210 includes one or more cameras, such as left camera 1239A and right camera 1239B, which can be analogous to left and right cameras 1139A and 1139B on frame 1104 of eyewear device 1102. In some embodiments, VR system 1210 includes one or more additional cameras (e.g., cameras 1239C and 1239D), which can be configured to augment image data obtained by left and right cameras 1239A and 1239B by providing more information. For example, camera 1239C can be used to supply color information that is not discerned by cameras 1239A and 1239B. In some embodiments, one or more of cameras 1239A to 1239D can include an optional IR cut filter configured to remove IR light from being received at the respective camera sensors.

FIG. 13 illustrates a computing system 1320 and an optional housing 1390, each of which show components that can be included in AR system 1100 and/or VR system 1210. In some embodiments, more or fewer components can be included in optional housing 1390 depending on practical restraints of the respective AR system being described.

In some embodiments, computing system 1320 can include one or more peripherals interfaces 1322A and/or optional housing 1390 can include one or more peripherals interfaces 1322B. Each of computing system 1320 and optional housing 1390 can also include one or more power systems 1342A and 1342B, one or more controllers 1346 (including one or more haptic controllers 1347), one or more processors 1348A and 1348B (as defined above, including any of the examples provided), and memory 1350A and 1350B, which can all be in electronic communication with each other. For example, the one or more processors 1348A and 1348B can be configured to execute instructions stored in memory 1350A and 1350B, which can cause a controller of one or more of controllers 1346 to cause operations to be performed at one or more peripheral devices connected to peripherals interface 1322A and/or 1322B. In some embodiments, each operation described can be powered by electrical power provided by power system 1342A and/or 1342B.

In some embodiments, peripherals interface 1322A can include one or more devices configured to be part of computing system 1320, some of which have been defined above and/or described with respect to the wrist-wearable devices shown in FIGS. 9 and 10. For example, peripherals interface 1322A can include one or more sensors 1323A. Some example sensors 1323A include one or more coupling sensors 1324, one or more acoustic sensors 1325, one or more imaging sensors 1326, one or more EMG sensors 1327, one or more capacitive sensors 1328, one or more IMU sensors 1329, and/or any other types of sensors explained above or described with respect to any other embodiments discussed herein.

In some embodiments, peripherals interfaces 1322A and 1322B can include one or more additional peripheral devices, including one or more NFC devices 1330, one or more GPS devices 1331, one or more LTE devices 1332, one or more Wi-Fi and/or Bluetooth devices 1333, one or more buttons 1334 (e.g., including buttons that are slidable or otherwise adjustable), one or more displays 1335A and 1335B, one or more speakers 1336A and 1336B, one or more microphones 1337, one or more cameras 1338A and 1338B (e.g., including the left camera 1339A and/or a right camera 1339B), one or more haptic devices 1340, and/or any other types of peripheral devices defined above or described with respect to any other embodiments discussed herein.

AR systems can include a variety of types of visual feedback mechanisms (e.g., presentation devices). For example, display devices in AR system 1100 and/or VR system 1210 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 1335A and 1335B can be coupled to each of the lenses 1106-1 and 1106-2 of AR system 1100. Displays 1335A and 1335B may be coupled to each of lenses 1106-1 and 1106-2, which can act together or independently to present an image or series of images to a user. In some embodiments, AR system 1100 includes a single display 1335A or 1335B (e.g., a near-eye display) or more than two displays 1335A and 1335B. In some embodiments, a first set of one or more displays 1335A and 1335B can be used to present an augmented-reality environment, and a second set of one or more display devices 1335A and 1335B can be used to present a virtual-reality environment. In some embodiments, one or more waveguides are used in conjunction with presenting artificial-reality content to the user of AR system 1100 (e.g., as a means of delivering light from one or more displays 1335A and 1335B to the user's eyes). In some embodiments, one or more waveguides are fully or partially integrated into the eyewear device 1102. Additionally, or alternatively to display screens, some artificial-reality systems include one or more projection systems. For example, display devices in AR system 1100 and/or VR system 1210 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 1335A and 1335B.

Computing system 1320 and/or optional housing 1390 of AR system 1100 or VR system 1210 can include some or all of the components of a power system 1342A and 1342B. Power systems 1342A and 1342B can include one or more charger inputs 1343, one or more PMICs 1344, and/or one or more batteries 1345A and 1344B.

Memory 1350A and 1350B may include instructions and data, some or all of which may be stored as non-transitory computer-readable storage media within the memories 1350A and 1350B. For example, memory 1350A and 1350B can include one or more operating systems 1351, one or more applications 1352, one or more communication interface applications 1353A and 1353B, one or more graphics applications 1354A and 1354B, one or more AR processing applications 1355A and 1355B, and/or any other types of data defined above or described with respect to any other embodiments discussed herein.

Memory 1350A and 1350B also include data 1360A and 1360B, which can be used in conjunction with one or more of the applications discussed above. Data 1360A and 1360B can include profile data 1361, sensor data 1362A and 1362B, media content data 1363A, AR application data 1364A and 1364B, and/or any other types of data defined above or described with respect to any other embodiments discussed herein.

In some embodiments, controller 1346 of eyewear device 1102 may process information generated by sensors 1323A and/or 1323B on eyewear device 1102 and/or another electronic device within AR system 1100. For example, controller 1346 can process information from acoustic sensors 1125-1 and 1125-2. For each detected sound, controller 1346 can perform a direction of arrival (DOA) estimation to estimate a direction from which the detected sound arrived at eyewear device 1102 of R system 1100. As one or more of acoustic sensors 1325 (e.g., the acoustic sensors 1125-1, 1125-2) detects sounds, controller 1346 can populate an audio data set with the information (e.g., represented in FIG. 10 as sensor data 1362A and 1362B).

In some embodiments, a physical electronic connector can convey information between eyewear device 1102 and another electronic device and/or between one or more processors 1148, 1348A, 1348B of AR system 1100 or VR system 1210 and controller 1346. The information can be in the form of optical data, electrical data, wireless data, or any other transmittable data form. Moving the processing of information generated by eyewear device 1102 to an intermediary processing device can reduce weight and heat in the eyewear device, making it more comfortable and safer for a user. In some embodiments, an optional wearable accessory device (e.g., an electronic neckband) is coupled to eyewear device 1102 via one or more connectors. The connectors can be wired or wireless connectors and can include electrical and/or non-electrical (e.g., structural) components. In some embodiments, eyewear device 1102 and the wearable accessory device can operate independently without any wired or wireless connection between them.

In some situations, pairing external devices, such as an intermediary processing device (e.g., HIPD 506, 606, 706) with eyewear device 1102 (e.g., as part of AR system 1100) enables eyewear device 1102 to achieve a similar form factor of a pair of glasses while still providing sufficient battery and computation power for expanded capabilities. Some, or all, of the battery power, computational resources, and/or additional features of AR system 1100 can be provided by a paired device or shared between a paired device and eyewear device 1102, thus reducing the weight, heat profile, and form factor of eyewear device 1102 overall while allowing eyewear device 1102 to retain its desired functionality. For example, the wearable accessory device can allow components that would otherwise be included on eyewear device 1102 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1102 standing alone. Because weight carried in the wearable accessory device can be less invasive to a user than weight carried in the eyewear device 1102, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1100 and/or VR system 1210 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 12A and 12B show VR system 1210 having cameras 1239A to 1239D, which can be used to provide depth information for creating a voxel field and a two-dimensional mesh to provide object information to the user to avoid collisions.

In some embodiments, AR system 1100 and/or VR system 1210 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1100 and/or VR system 1210, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive display data to be transformed, transform the display data, output a result of the transformation to display a corresponding frame, use the result of the transformation to super-sample and reproject the display data, and store the result of the transformation to reproject the display data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving a texture memory that represents a rendering of a display frame and includes a color value for each of a plurality of pixels;
receiving a coverage bitmap that represents a foreground object of the display frame with respect to the plurality of pixels;
reprojecting the texture memory using the coverage bitmap; and
displaying the reprojected texture memory on a display.

2. The computer-implemented method of claim 1, wherein reprojecting the texture memory using the coverage bitmap further comprises:
determining an original background color with respect to the display frame;
determining an original foreground color of the display frame that corresponds to the foreground object; and
using the original background color and the original foreground color to calculate color values for the reprojected texture memory.

3. The computer-implemented method of claim 2, wherein the original foreground color corresponds to a plurality of background colors, wherein the display frame is divided into subframes based on grouping common background colors.

4. The computer-implemented method of claim 1, wherein the coverage bitmap indicates a number of subpixels, for each of the plurality of pixels of the texture memory, included in the foreground object.

5. The computer-implemented method of claim 1, wherein the coverage bitmap is encoded as a bitmask pattern.

6. The computer-implemented method of claim 5, wherein the bitmask pattern includes using one or more leading bits as a header and remaining bits as a value from a compression table.

7. The computer-implemented method of claim 1, wherein the color value for each of the plurality of pixels corresponds to multiple color channels.

8. The computer-implemented method of claim 7, further comprising:
detecting an out-of-bound value for at least one of the color channels for the plurality of pixels of the reprojected texture memory; and
performing a reprojection color correction.

9. The computer-implemented method of claim 8, wherein performing the reprojection color correction includes:
identifying a color channel of the multiple color channels having a largest out-of-bound value;
adjusting the largest out-of-bound value to a nearest boundary value for a foreground color of the foreground object; and
recalculating the reprojected texture memory using the adjusted foreground color.

10. The computer-implemented method of claim 8, wherein one of the multiple color channels corresponds to an alpha channel.

11. The computer-implemented method of claim 10, wherein the coverage bitmap is encoded in the alpha channel.

12. A system comprising:
a display;
at least one physical processor;
physical memory comprising computer-executable instructions that, when executed by the physical processor, cause the physical processor to:
receive a texture memory that represents a rendering of a display frame and includes a color value for each of a plurality of pixels;
receive a coverage bitmap that represents a foreground object of the display frame with respect to the plurality of pixels;
reproject the texture memory using the coverage bitmap; and
display the reprojected texture memory on the display.

13. The system of claim 12, wherein instructions for reprojecting the texture memory using the coverage bitmap comprises instructions for:
determining an original background color with respect to the display frame;
determining an original foreground color of the display frame that corresponds to the foreground object; and
using the original background color and the original foreground color to calculate color values for the reprojected texture memory.

14. The system of claim 13, wherein the original foreground color corresponds to a plurality of background colors, wherein the display frame is divided into subframes based on grouping common background colors.

15. The system of claim 12, wherein:
the coverage bitmap is encoded as a bitmask pattern that indicates a number of subpixels, for each of the plurality of pixels of the texture memory, included in the foreground object; and
the bitmask pattern includes using one or more leading bits as a header and remaining bits as a value from a compression table.

16. The system of claim 12, wherein:
the color value for each of the plurality of pixels corresponds to multiple color channels; and
the instructions further include instructions for:
detecting an out-of-bound value for at least one of the color channels for the plurality of pixels of the reprojected texture memory; and
performing a reprojection color correction.

17. The system of claim 16, wherein the instructions for performing the reprojection color correction includes instructions for:
identifying a color channel of the multiple color channels having a largest out-of-bound value;
adjusting the largest out-of-bound value to a nearest boundary value for a foreground color of the foreground object; and
recalculating the reprojected texture memory using the adjusted foreground color.

18. The system of claim 17, wherein one of the multiple color channels corresponds to an alpha channel.

19. The system of claim 18, wherein the coverage bitmap is encoded in the alpha channel.

20. A non-transitory computer-readable medium comprising one or more computer-executable instructions that, when executed by at least one processor of a computing device, cause the computing device to:
receive a texture memory that represents a rendering of a display frame and includes a color value for each of a plurality of pixels;
receive a coverage bitmap that represents a foreground object of the display frame with respect to the plurality of pixels;
reproject the texture memory using the coverage bitmap; and
display the reprojected texture memory on a display.
